(19) United States
(12) Patent Application Publication
(10) Pub. No.: US 2018/0025630 A1
(43) Pub. Date: Jan. 25, 2018

(54) ROADSIDE COMMUNICATION DEVICE, DATA RELAY METHOD, CENTRAL APPARATUS, COMPUTER PROGRAM, AND DATA PROCESSING METHOD

(71) Applicant: SUMITOMO ELECTRIC INDUSTRIES, LTD., Osaka-shi, Osaka (JP)

(72) Inventors: Hiroshi MATSUMOTO, Osaka (JP); Shigeki UMEHARA, Osaka (JP); Masafumi KOBAYASHI, Osaka (JP)

(73) Assignee: SUMITOMO ELECTRIC INDUSTRIES, LTD., Osaka-shi, Osaka (JP)

(21) Appl. No.: 15/550,420

(22) PCT Filed: Mar. 9, 2016
(86) PCT No.: PCT/JP2016/057410

§ 371 Date: Aug. 11, 2017

(30) Foreign Application Priority Data
Mar. 10, 2015 (JP) 2015-047084

(51) Int. Cl. G08G 1/01; G08G 1/081

(52) U.S. Cl. CPC G08G 1/0112; G08G 1/081

(57) ABSTRACT

A roadside communication device having a data relay function includes a receiving unit that receives mobile object data whose generator is a mobile object; a relay unit capable of relaying the mobile object data, the relaying involving a thinning process of an amount of data; and a transmitting unit that transmits thinning information about an execution status of the thinning process to an external device.

### TECHNICAL FIELD

The present invention relates to a roadside communication device, a data relay method, a central apparatus, a computer program, and a data processing method.

This application claims priority to Japanese Patent Application No. 2015-047084 filed Mar. 10, 2015, the entire content of which is incorporated herein by reference.

### BACKGROUND ART

In recent years, as part of intelligent transport systems (ITS), it has been considered to transmit information transmitted and received by vehicle-to-vehicle communication which is a 700 MHz band radio system to a central apparatus, and utilize the information for traffic control by the central apparatus.

Such intelligent transport systems are mainly composed of a plurality of roadside wireless devices which are wireless communication devices on the roadside installed near intersections; and a plurality of on-vehicle wireless devices which are wireless communication devices mounted on vehicles. The plurality of roadside wireless devices are capable of transmitting and receiving information to/from, for example, a central apparatus installed at a traffic control center through communication lines.

In the intelligent transport systems, combinations of communication performed between communication entities are assumed to include roadside-to-vehicle communication where a roadside wireless device radio-transmits various types of information to an on-vehicle wireless device, and vehicle-to-vehicle communication where on-vehicle wireless devices perform radio communication with each other. The roadside wireless device can intercept vehicle data including time information, location information, and the like, which are transmitted and received by vehicle-to-vehicle communication. Therefore, by the roadside wireless device transmitting vehicle data obtained from vehicles, to the central apparatus, the central apparatus can use the vehicle data for traffic signal control (see Non-Patent Literatures 1 and 2).

### CITATION LIST

### Non-Patent Literature

Non-Patent Literature 1: ITS Info-communications Forum, “700 MHz BAND INTELLIGENT TRANSPORT SYSTEMS—Extended Functions Guideline ITS FORUM RC-010 ver. 1.0”, [online], Mar. 15, 2012, [searched on Feb. 5, 2015], Internet <http://www.itsforum.gr.jp/>

Non-Patent Literature 2: ITS Info-communications Forum, “700 MHz BAND INTELLIGENT TRANSPORT SYSTEMS—Experimental Inter-vehicle Communication Messages ITS FORUM RC-013 ver. 1.0)”, [online], Mar. 31, 2014, [searched on Feb. 5, 2015], Internet <http://www.itsforum.gr.jp/>

### SUMMARY OF INVENTION

A roadside communication device of the present disclosure is a roadside communication device having a data relay function and including: a receiving unit that receives mobile object data whose generator is a mobile object; a relay unit capable of relaying the mobile object data, the relaying involving a thinning process of an amount of data; and a transmitting unit that transmits thinning information about an execution status of the thinning process to an external device.

A data relay method of the present disclosure is a data relay method for a roadside communication device having a data relay function, the data relay method including: a first step of receiving, by a receiving unit of the roadside communication device, mobile object data whose generator is a mobile object; a second step of relaying the mobile object data by a relay unit of the roadside communication device, the relaying involving a thinning process of an amount of data; and a third step of transmitting, by a transmitting unit of the roadside communication device, thinning information about an execution status of the thinning process to an external device.

A central apparatus of the present disclosure is a central apparatus capable of obtaining mobile object data whose generator is a mobile object, from a roadside communication device having a data relay function involving a thinning process of an amount of data, the central apparatus including: a communication unit that receives thinning information about an execution status of the thinning process from the roadside communication device; and a control unit that performs a predetermined process based on the thinning information received by the communication unit.

A computer program of the present disclosure is a computer program for causing a computer to perform a process to be performed by a central apparatus capable of obtaining mobile object data whose generator is a mobile object, from a roadside communication device having a data relay function involving a thinning process of an amount of data, the computer program causing the computer to function as: a communication unit that receives thinning information about an execution status of the thinning process from the roadside communication device; and a control unit that performs a predetermined process based on the thinning information received by the communication unit.

A data processing method of the present disclosure is a data processing method for a central apparatus capable of obtaining mobile object data whose generator is a mobile object, from a roadside communication device having a data relay function involving a thinning process of an amount of data, the data processing method including: a first step of receiving, by a communication unit of the central apparatus, thinning information about an execution status of the thinning process from the roadside communication device; and a second step of performing, by a control unit of the central apparatus, a predetermined process based on the thinning information received by the communication unit.

### BRIEF DESCRIPTION OF DRAWINGS

FIG. 1 is a perspective view showing an overall configuration of a traffic control system according to a common embodiment.

FIG. 2 is a road plan view of an intersection included in a control area of a central apparatus.

FIG. 3 is a road plan view showing an exemplary configuration of an ITS radio system.

FIG. 4 is a block diagram showing a configuration of the central apparatus.

FIG. 5 is a block diagram showing the configurations of a roadside wireless device and an on-vehicle wireless device.

FIG. 6 is a conceptual diagram showing an example of time slots applied to the roadside wireless devices.

FIG. 7 is a diagram showing a data format of a communication frame used for vehicle-to-vehicle communication.

FIGS. 8(a) and 8(b) are diagrams showing the data formats of vehicle data used upon uplink transmission.

FIG. 9 is a table showing the contents of a plurality of types of thinning processes.

FIG. 10 is a road plan view of a plurality of intersections to which one of the thinning processes is applied.

FIG. 11 is a flowchart showing an example of a data relaying process by a roadside wireless device of a first embodiment.

FIG. 12 is a flowchart showing an example of data processing by a central apparatus of the first embodiment.

FIG. 13 is a flowchart showing an example of a data relaying process by a roadside wireless device of a second embodiment.

FIG. 14 is a flowchart showing an example of data processing by a central apparatus of the second embodiment.

FIG. 15 is a flowchart showing an example of a data relaying process by a roadside wireless device of a third embodiment.

FIG. 16 is a flowchart showing an example of data processing by a central apparatus of the third embodiment.

### DESCRIPTION OF EMBODIMENTS

### Problem to be Solved by the Present Disclosure

In the above-described intelligent transport systems, when pieces of vehicle data which are transmitted and received by vehicle-to-vehicle communication are aggregated on the central apparatus, it is preferred to collect as much vehicle data as possible in order to perform more advanced traffic signal control.

However, if pieces of vehicle data obtained from a large number of on-vehicle wireless devices which are present in a communication area of a roadside wireless device are transmitted as they are to the central apparatus from the roadside wireless device, then, for example, the amount of data transmission in an uplink direction of a communication line (a metal line under the present conditions) connected to the central apparatus becomes excessive, which may cause an overload of the communication line.

In this case, it is desirable that the central apparatus side grasp the execution status of a vehicle data thinning process by a roadside wireless device.

In view of such circumstances, an object is therefore to allow an external device such as a central apparatus to be able to grasp the execution status of a thinning process by a roadside communication device.

### Advantageous Effect of the Present Disclosure

According to the present disclosure, an external device such as a central apparatus can grasp the execution status of a thinning process by a roadside communication device.

### Description of Embodiments of the Present Invention

First, the content of embodiments of the present invention will be listed and described.

(1) A roadside communication device according to an embodiment of the present invention is a roadside communication device having a data relay function and including: a receiving unit that receives mobile object data whose generator is a mobile object; a relay unit capable of relaying the mobile object data, the relaying involving a thinning process of an amount of data; and a transmitting unit that transmits thinning information about an execution status of the thinning process to an external device.

According to the roadside communication device configured in the above-described manner, since the transmitting unit transmits thinning information about the execution status of a thinning process to the external device, the external device can grasp the execution status of a thinning process by the roadside communication device.

(2) In the above-described roadside communication device, it is preferred that the thinning information include thinning execution information indicating whether the thinning process has been executed.

In this case, the external device can grasp, by the above-described thinning execution information, whether the roadside communication device has executed a thinning process.

(3) In the above-described roadside communication device, the thinning information may include thinning condition information that allows to identify a thinning condition actually used in the thinning process.

In this case, the external device can grasp, by the above-described thinning condition information, a thinning condition actually used in a thinning process by the roadside communication device.

(4) In the above-described roadside communication device, the thinning information may include number-of-mobile-object information indicating a number of mobile objects each of which is a generator of mobile object data received before the thinning process.

In this case, the external device can grasp, by the above-described number-of-mobile-object information, the number of mobile objects that are the generators of pieces of mobile object data collected by the roadside communication device before a thinning process.

(5) In the above-described roadside communication device, the thinning information may include processing load information indicating a processing load of the roadside communication device.

In this case, the external device can grasp, by the above-described processing load information, the accuracy of mobile object data obtained from the roadside communication device. For example, the external device can grasp that mobile object data obtained from the roadside communication device has low accuracy when the roadside communication device has a high processing load according to the above-described processing load information, and can grasp that mobile object data obtained from the roadside communication device has high accuracy when the roadside communication device has a low processing load according to the above-described processing load information.

(6) A data relay method of the present embodiment is a data relay method to be performed by the above-described roadside communication device. Therefore, the data relay method of the present embodiment provides the same functions and effects as the above-described roadside communication device.

(7) A central apparatus according to an embodiment of the present invention is a central apparatus capable of obtaining mobile object data whose generator is a mobile object, from a roadside communication device having a data relay function involving a thinning process of an amount of data, the central apparatus including: a communication unit that receives thinning information about an execution status of the thinning process from the roadside communication device; and a control unit that performs a predetermined process based on the thinning information received by the communication unit.

According to the central apparatus configured in the above-described manner, by the receiving unit receiving thinning information about the execution status of a thinning process from the roadside communication device, the central apparatus can grasp the execution status of a thinning process by the roadside communication device.

In addition, since the control unit performs a predetermined process based on the received thinning information, the central apparatus can perform an appropriate process that suits the execution status of a thinning process by the roadside communication device.

(8) It is preferred that the above-described central apparatus further include a thinning execution instructing unit that outputs an instruction on execution of the thinning process to the roadside communication device, the thinning information include thinning execution information indicating whether the thinning process has been executed, and as the predetermined process, the control unit detect an abnormality in the thinning process by comparing the instruction outputted by the thinning execution instructing unit with the thinning execution information.

In this case, the central apparatus side can detect an abnormality in a thinning process by comparing an instruction outputted by the thinning execution instructing unit with thinning execution information obtained from the roadside communication device, to determine whether the execution or non-execution of a thinning process matches between the instruction and the thinning execution information.

(9) The central apparatus may further include a thinning condition instructing unit that outputs an instruction on a thinning condition of the thinning process to the roadside communication device, the thinning information may include thinning condition information that allows to identify a thinning condition actually used by the roadside communication device, and as the predetermined process, the control unit may detect an abnormality in the thinning process by comparing the instruction outputted by the thinning condition instructing unit with the thinning condition information.

In this case, the central apparatus side can detect an abnormality in a thinning process by comparing an instruction outputted by the thinning condition instructing unit with thinning condition information obtained from the roadside communication device, to determine whether the thinning condition matches between the instruction and the thinning condition information.

(10) In the above-described central apparatus, the thinning information may include at least one of thinning execution information, thinning condition information, and processing load information, the thinning execution information indicating whether the thinning process has been executed, the thinning condition information allowing to identify a thinning condition actually used by the roadside communication device, and the processing load information indicating a processing load of the roadside communication device, and as the predetermined process, the control unit may determine, for at least one of a traffic flow diagnosis process and a calculation process for various amounts of traffic, whether the process can be performed, based on the thinning information.

In this case, the central apparatus can determine, for at least one of a traffic flow diagnosis process and a calculation process for various amounts of traffic, whether the process can be performed, based on at least one of thinning execution information, thinning condition information, and processing load information which are obtained from the roadside communication device. For example, when the roadside communication device has a high processing load according to processing load information, mobile object data has low reliability, and thus, the control unit can determine not to perform a calculation process for various amounts of traffic from the mobile object data.

(11) In the above-described central apparatus, the thinning information may include number-of-mobile-object information indicating a number of mobile objects each of which is a generator of mobile object data relayed by the roadside communication device before the thinning process, and as the predetermined process, the control unit may calculate various amounts of traffic based on the number-of-mobile-object information.

In this case, the central apparatus can calculate various amounts of traffic such as the amount of traffic of mobile objects for before a thinning process, based on number-of-mobile-object information obtained from the roadside communication device.

(12) The above-described central apparatus may further include a thinning condition instructing unit that outputs an instruction on a thinning condition of the thinning process to the roadside communication device, the thinning information may include processing load information indicating a processing load of the roadside communication device, and as the predetermined process, the control unit may change the thinning condition to be instructed to the roadside communication device, according to the processing load information.

In this case, the central apparatus can change the thinning condition according to the processing load of the roadside communication device. For example, the control unit can change the thinning condition to one for a low processing load when the roadside communication device has a high processing load, and can change the thinning condition to one for a high processing load when the roadside communication device has a low processing load.

(13) A computer program according to an embodiment of the present invention is a computer program for causing a computer to function as the above-described central apparatus. Therefore, the computer program of the present embodiment provides the same functions and effects as the above-described central apparatus.

(14) A data processing method of the present embodiment is a data processing method to be performed by the above-described central apparatus. Therefore, the data processing method of the present embodiment provides the same functions and effects as the above-described central apparatus.

### Details of the Embodiments of the Present Invention

Details of embodiments of the present invention will be described below with reference to the drawings. Note that at least some of the embodiments described below may be arbitrarily combined.

<Definitions of Terms>

In describing the details of the embodiments, first, terms used in the embodiments are defined.

“Mobile object”: A collective term for objects that pass through passable regions such as public roads, private roads, and parking lots. The mobile objects of the embodiments include “vehicles” which will be described later and pedestrians.

“Vehicle”: Vehicles in general that can pass through roads. Specifically, the vehicles refer to vehicles defined by the Road Traffic Law. The vehicles defined by the Road Traffic Law include automobiles, motorbikes, light vehicles, and trolleybuses.

“Traffic signal controller”: Refers to a controller that controls timing at which signal light units at an intersection are turned on and off.

“Roadside detector”: Refers to a sensor device installed to sense the passing states of vehicles. The roadside detectors include vehicle sensors, surveillance cameras, optical beacons, and the like.

“Roadside communication device”: Refers to a communication device installed on the roadside (infrastructure side). The roadside communication devices include roadside wireless devices which will be described later. When an information relay device is interposed for wired communication between a roadside wireless device and a central apparatus, the information relay device is also included in the roadside communication device.

“Wireless communication device”: Refers to a device that has a communication function of transmitting and receiving, by radio, communication frames conforming to a predetermined protocol and that serves as a transmitting and receiving entity for radio communication. The wireless communication devices include roadside wireless devices and mobile radios which will be described later.

“Roadside wireless device”: Refers to a wireless communication device installed on the roadside (infrastructure side). In the embodiments, the roadside wireless device refers to a wireless communication device capable of performing roadside-to-roadside communication with another roadside wireless device and roadside-to-vehicle communication with an on-vehicle wireless device.

“Mobile radio”: Refers to a wireless communication device mounted on a mobile object (“carried by” in the case of a passenger and a pedestrian). The mobile radios of the embodiments include on-vehicle wireless devices and portable terminals which will be described later.

“On-vehicle wireless device”: Refers to a wireless communication device permanently or temporarily mounted on a vehicle. A portable terminal such as a mobile phone or a smartphone carried on a vehicle by a passenger also corresponds to an on-vehicle wireless device if the portable terminal can perform radio communication with a roadside wireless device.

“Portable terminal”: Refers to a wireless communication device carried by a vehicle passenger or a pedestrian. Specifically, mobile phones, smartphones, tablet computers, notebook personal computers, etc., correspond to the portable terminals.

“Communication frame”: A collective term for PDUs (Protocol Data Units) used for radio communication by wireless communication devices and PDUs used for wired communication by roadside communication devices including roadside wireless devices.

“Mobile object data”: Refers to data whose generators are a vehicle and a portable terminal. The mobile object data includes vehicle data which will be described later.

“Vehicle data”: Refers to data whose generator is a vehicle. For example, data such as a time, a vehicle location, and an azimuth measured by the vehicle corresponds to the vehicle data.

“Roadside data”: Refers to data whose generators are a traffic signal controller, a roadside detector, and a roadside communication device. For example, control signal execution information generated by a traffic signal controller and detection information measured by a roadside detector correspond to the roadside data.

### Common Embodiment

<Overall Configuration of a System>

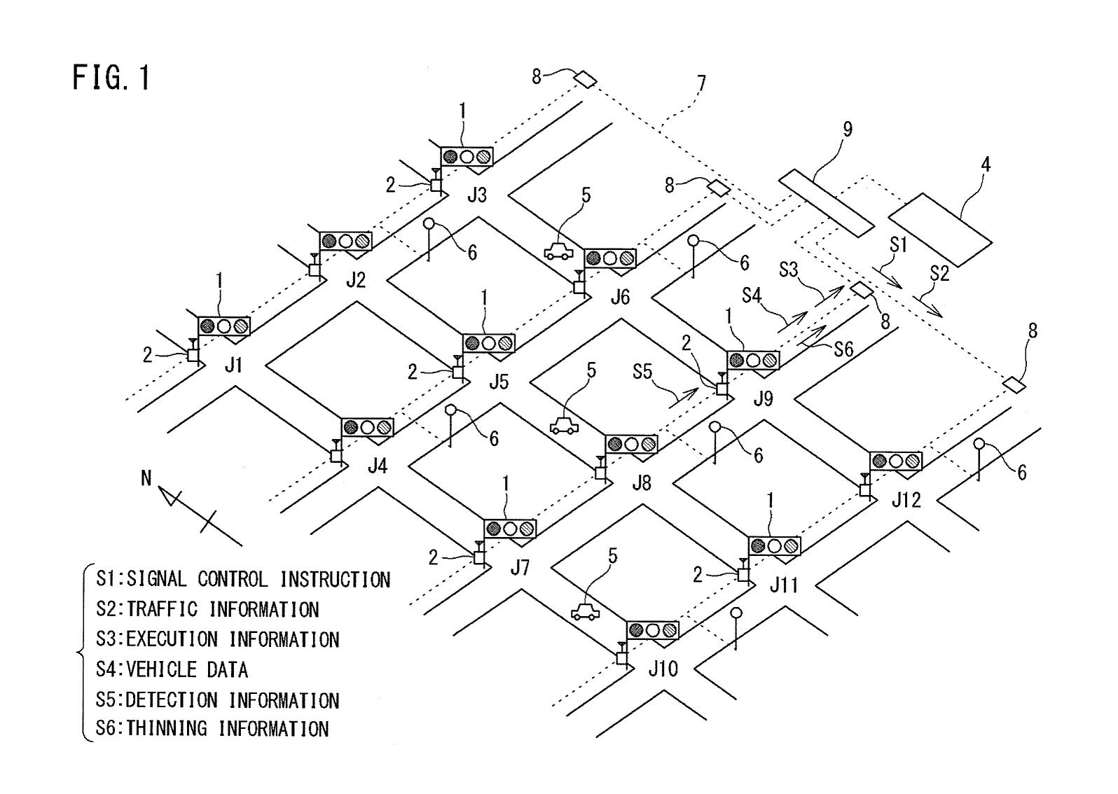

FIG. 1 is a perspective view showing an overall configuration of a traffic control system according to a common embodiment.

Although FIG. 1 exemplifies, as an example of a road structure, a square-pattern structure where a plurality of roads in a north-south direction and an east-west direction intersect each other, the road structure is not limited thereto.

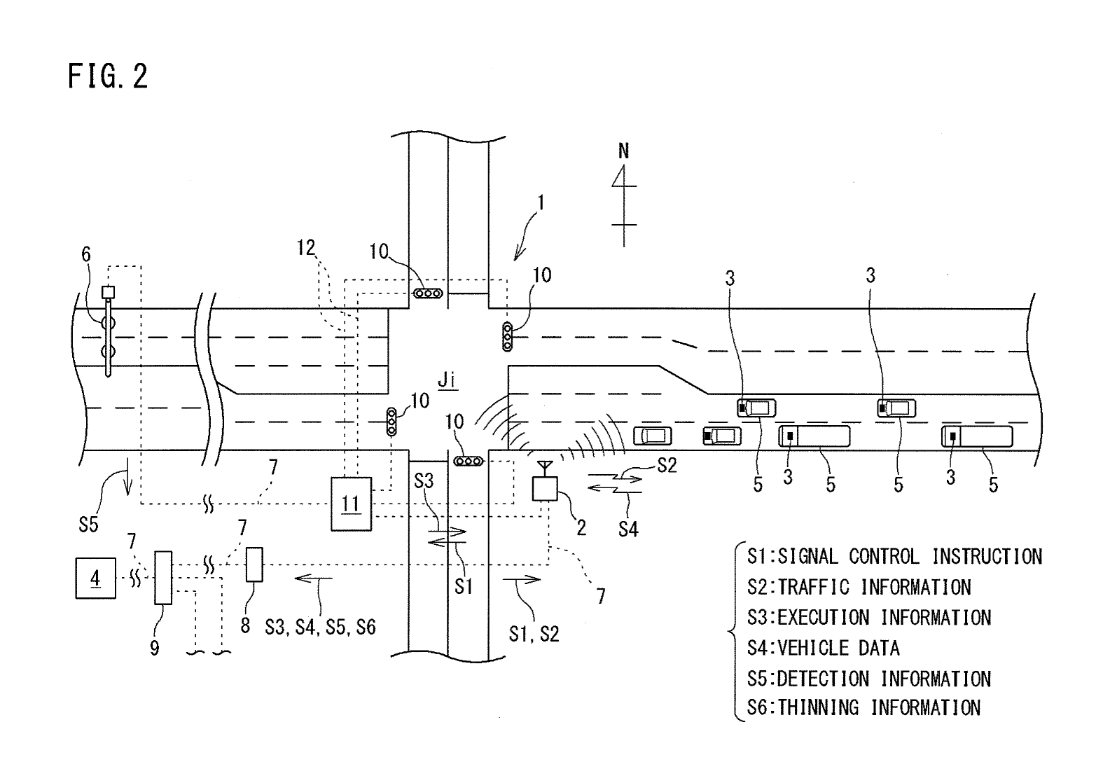

As shown in FIG. 1, a traffic signal control system of the embodiment includes traffic signal units 1, roadside wireless devices 2, on-vehicle wireless devices 3 (see FIGS. 2 to 4), a central apparatus 4, vehicles 5 having mounted thereon the on-vehicle wireless devices 3, roadside detectors 6, and the like.

The traffic signal units 1 and the roadside wireless devices 2 are installed at respective intersections Ji (in FIG. 1, i=1 to 12) included in a control area of the central apparatus 4, and are connected to multi-stage routers 8 and 9 through communication lines 7. The routers 8 of the first stage which are the closer ones to the intersections are provided in a plural number in the control area.

To each router 8 of the first stage are connected traffic signal units 1 and roadside wireless devices 2 provided at respective intersections Ji (e.g., i=1 to 3). Communication lines 7 extending to the central apparatus 4 side from the plurality of routers 8 are aggregated at the router 9 of the second stage, and the router 9 of the second stage is further connected to the central apparatus 4 by a communication line 7.

The communication lines 7 are made of, for example, metal lines. For a communication system of communication devices using the communication lines 7 as communication media, an ISDN (Integrated Services Digital Network) system is adopted.

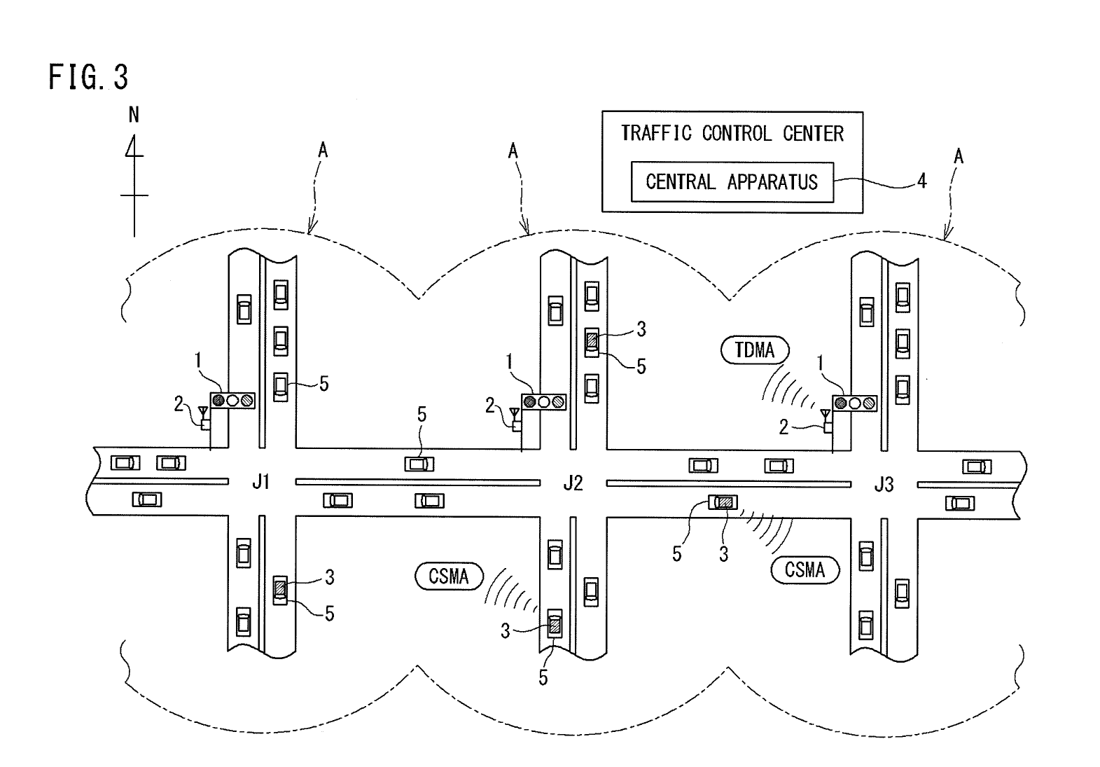

The central apparatus 4 is installed in a traffic control center (see FIG. 3). The central apparatus 4 forms a LAN (Local Area Network) with the traffic signal units 1 and the roadside wireless devices 2 at the intersections Ji which are included in its control area.

Therefore, the central apparatus 4 can perform two-way communication with each traffic signal unit 1 and each roadside wireless device 2. Note that the central apparatus 4 may be installed on a road instead of in the traffic control center.

The roadside detectors 6 are installed at various locations on roads in the control area for the main purpose of counting the number of vehicles flowing into the intersections Ji.

The roadside detectors 6 include at least one of, for example, a vehicle sensor that senses vehicles 5 passing just thereunderneath by an ultrasonic wave, a surveillance camera that films the passing conditions of vehicles 5 in chronological order, and an optical beacon that performs optical communication by near infrared rays with vehicles 5.

As shown in FIG. 1, information to be transmitted to the communication line 7 by the central apparatus 4 (hereinafter, referred to as “downlink information”) includes a signal control instruction S1, traffic information S2, and the like.

The signal control instruction S1 is information indicating the timing of changing the lamp color at a traffic signal unit 1 (e.g., a cycle start time and the number of step execution seconds), and is transmitted to a traffic signal controller 11 (see FIG. 2). The traffic information S2 is, for example, traffic jam information and traffic control information, and is transmitted to the roadside wireless devices 2, the optical beacons of the roadside detectors 6, etc.

Information received by the central apparatus 4 through the communication lines 7 (hereinafter, referred to as “uplink information”) includes control signal execution information S3, vehicle data S4, detection information S5, thinning information S6, and the like.

The signal control execution information (hereinafter, referred to as “execution information”) S3 is information indicating the actual results of control that is actually performed by a traffic signal controller 11 in the last cycle. Therefore, the generator of the execution information S3 is the traffic signal controller 11.

The vehicle data S4 is, as described above, data whose generator is a vehicle 5. The vehicle data S4 includes the time information, location information, etc., of the vehicle 5 at a time point of generation of the data. Therefore, by arranging pieces of location information of a plurality of pieces of vehicle data S4 for the same vehicle ID in chronological order, probe data that allows to identify a traveling path of a vehicle 5 is obtained.

The detection information S5 is information indicating measurement results obtained by a roadside detector 6, and includes sensed information of a vehicle sensor, image data of a surveillance camera, etc. Therefore, the generator of the detection information S5 is the roadside detector 6.

The thinning information S6 is information about the execution status of a thinning process of vehicle data S4 by a roadside wireless device 2 (described later), and includes information indicating whether a thinning process has been executed, etc.

<Connection Form of Communication Lines>

FIG. 2 is a road plan view of an intersection Ji included in the control area of the central apparatus 4.

As shown in FIG. 2, a traffic signal unit 1 includes a plurality of signal light units 10 that show flow-in roads at the intersection Ji information as to whether there is the right to pass through; and a traffic signal controller 11 that controls timing at which the signal light units 10 are turned on and off. The signal light units 10 are connected to the traffic signal controller 11 through predetermined signal control lines 12.

A roadside wireless device 2 is installed near the intersection Ji so that the roadside wireless device 2 can perform radio communication with vehicles 5 that pass through roads branching from the intersection Ji. Therefore, the roadside wireless device 2 can receive radio waves transmitted from vehicles 5 that perform vehicle-to-vehicle communication on the roads by on-vehicle wireless devices 3.

A roadside detector 6 is connected to the traffic signal controller 11 through a communication line 7 in a communicable manner, and the traffic signal controller 11 is connected to the roadside wireless device 2 through a communication line 7 in a communicable manner. Note that the traffic signal controller 11 may be connected to a router 8 without through the roadside wireless device 2.

The traffic signal controller 11 transmits generated execution information S3 to the roadside wireless device 2, and the roadside detector 6 transmits measured detection information S5 to the roadside wireless device 2 through the traffic signal controller 11.

When the roadside wireless device 2 receives the execution information S3 and the detection information S5, the roadside wireless device 2 uplink-transmits the information S3 and S5 to the central apparatus 4. In addition, when the roadside wireless device 2 receives vehicle data S4, the roadside wireless device 2 uplink-transmits the vehicle data S4 to the central apparatus 4. Furthermore, the roadside wireless device 2 uplink-transmits thinning information S6 generated thereby to the central apparatus 4.

When downlink information from the central apparatus 4 includes a signal control instruction S1, the roadside wireless device 2 transfers the received signal control instruction S1 to the traffic signal controller 11.

In addition, when downlink information from the central apparatus 4 includes traffic information S2, the roadside wireless device 2 radio-transmits the traffic information S2 by broadcast so as to provide the received traffic information S2 to vehicles 5.

The execution information S3, vehicle data S4, and detection information S5 which are uplink-transmitted by the roadside wireless device 2 are transmitted to the central apparatus 4 by wired communication using communication lines 7 via the router 8 of the first stage and the router 9 of the second stage.

Note that, in FIG. 2, by connecting a communication line 7 on the upstream side of the traffic signal controller 11 to the router 8, the traffic signal controller 11 may transmit the execution information S3 and the detection information S5 to the central apparatus 4 without through the roadside wireless device 2.

Meanwhile, if the mounting rate of the on-vehicle wireless devices 3 increases with progress in the proliferation of an ITS radio system, then the amount of vehicle data S4 obtained by the roadside wireless device 2 also increases. Due to this, the amount of data to be uplink-transmitted to the communication line 7 by the roadside wireless device 2 increases, and accordingly, the communication line 7 is expected to become overloaded.

Under the present conditions, particularly, since the communication line 7 is made of a relatively low-speed ISDN line, it is considered to be highly possible that the communication line 7 becomes overloaded with an increase in the amount of vehicle data S4.

In addition, in the example of FIG. 2, the router 9 of the second stage is smaller in number than the router 8 of the first stage and the communication lines 7 are aggregated at the router 9 of the second stage. Thus, communication in an uplink direction between the router 9 of the second stage and the central apparatus 4 is considered to become a bottleneck.

Hence, in the embodiment, in order to suppress the overload of the communication lines 7 that transmit uplink information to the central apparatus 4 (particularly, the communication line 7 directly connected to the central apparatus 4), the roadside wireless device 2 performs a data thinning process when relaying uplink information, the details of which will be described later.

<Radio Communication System, Etc.>

FIG. 3 is a road plan view showing an exemplary configuration of an ITS radio system.

In FIG. 3, for simplification of the drawing, all roads are depicted to have one lane in one direction; however, for example, when a main road runs in the east-west direction and a sub-road runs in the north-south direction (see FIG. 2), the road structure is not limited to that shown in FIG. 3.

As shown in FIG. 3, the ITS radio system of the embodiment is a radio communication system for adopting pieces of vehicle data S4 which are transmitted and received by vehicle-to-vehicle communication between vehicles 5, into traffic control of the central apparatus 4.

Specifically, the ITS radio system of the embodiment includes a plurality of roadside wireless devices 2 capable of performing radio communication with on-vehicle wireless devices 3; and the on-vehicle wireless devices 3 that perform radio communication with other wireless communication devices 2 and 3 by a carrier sense system.

The roadside wireless devices 2 are installed at respective intersections Ji, and mounted on signal light unit poles of traffic signal units 1. The on-vehicle wireless devices 3 are mounted on some or all of the vehicles 5 traveling the roads.

An on-vehicle wireless device 3 mounted on a vehicle 5 can receive, in an area where radio waves transmitted from a roadside wireless device 2 reach, the transmitted radio waves. In addition, the roadside wireless device 2 can receive, in an area where radio waves transmitted from the on-vehicle wireless device 3 reach, the transmitted radio waves.

Here, it is assumed that the distance at which the transmitted radio waves of the on-vehicle wireless device 3 reach is less than or equal to the distance at which the transmitted radio waves of the roadside wireless device 2 reach. Therefore, the roadside wireless device 2 can receive radio waves transmitted from on-vehicle wireless devices 3 located within a range of a communication area A which is a downlink area thereof.

Combinations of communication entities in the ITS radio system are classified into “vehicle-to-vehicle communication” which is communication between on-vehicle wireless devices 3, “roadside-to-vehicle communication” which is communication between a roadside wireless device 2 and an on-vehicle wireless device 3, and “roadside-to-roadside communication” which is communication between roadside wireless devices 2.

For a multiple access system that allows the above-described three types of communication to coexist, frequency division multiple access (FDMA), code division multiple access (CDMA), etc., can be adopted.

In a case of improving the priority of transmission by the roadside wireless devices 2, a multiple access system that follows the “700 MHz band intelligent transport systems standard (ARIB STD-T109)” may be adopted. In the embodiment, it is assumed that this system is adopted.

The above-described multiple access system following the standard is a system in which a time slot dedicated for transmission by roadside wireless devices 2 is assigned by a TDMA (Time Division Multiple Access) system, and a time slot other than the time slot dedicated for the roadside is assigned to vehicle-to-vehicle communication by a CSMA/CA (Carrier Sense Multiple Access/Collision Avoidance) system.

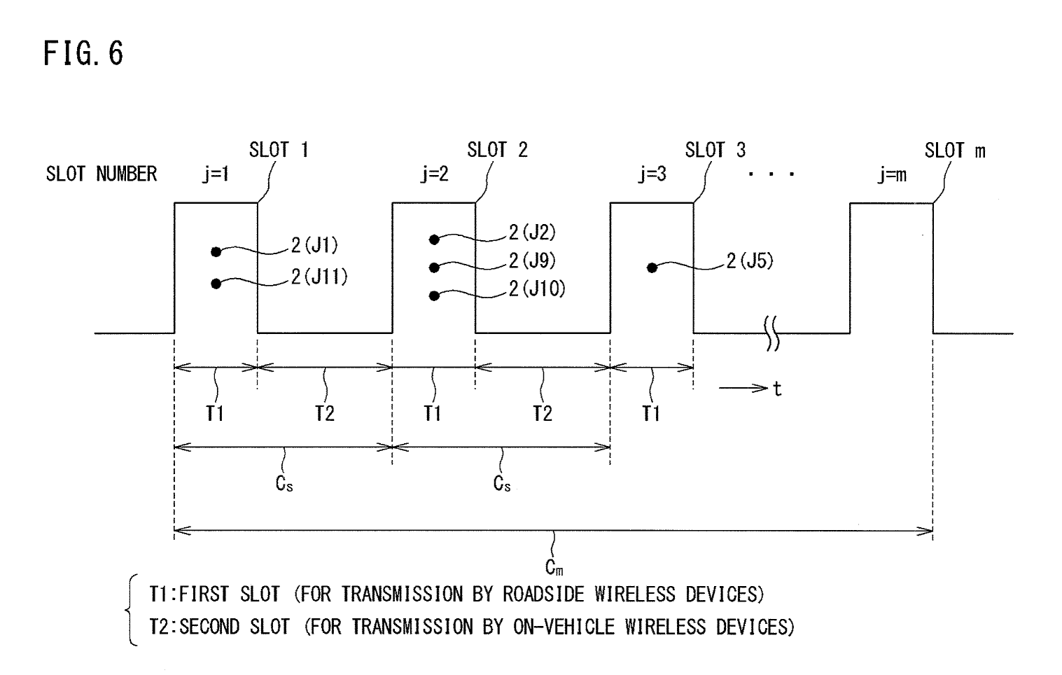

According to this system, roadside wireless devices 2 do not perform radio transmission during a time slot (a second slot T2 of FIG. 6) other than a time slot dedicated therefor (a first slot T1 of FIG. 6). Namely, the time slot other than the time slot for the roadside wireless devices 2 is open as a transmission time period by the CSMA system for on-vehicle wireless devices 3.

In addition, a roadside wireless device 2 receives radio waves transmitted by vehicle-to-vehicle communication, without negotiating with on-vehicle wireless devices 3, and thereby obtains information exchanged by the vehicle-to-vehicle communication.

Furthermore, in the roadside wireless devices 2, in order to prevent radio waves transmitted from a plurality of roadside wireless devices 2 from simultaneously reaching an on-vehicle wireless device 3, causing interference, roadside wireless devices 2 at adjacent intersections Ji use different time slots.

Hence, each roadside wireless device 2 has a time synchronization function of synchronizing a time with other roadside wireless devices 2. Time synchronization of the roadside wireless device 2 is performed by, for example, GPS synchronization where a time of the roadside wireless device 2 is synchronized with a GPS time, or air synchronization where a clock of the roadside wireless device 2 is synchronized with a transmit signal from another roadside wireless device 2.

<Central Apparatus >

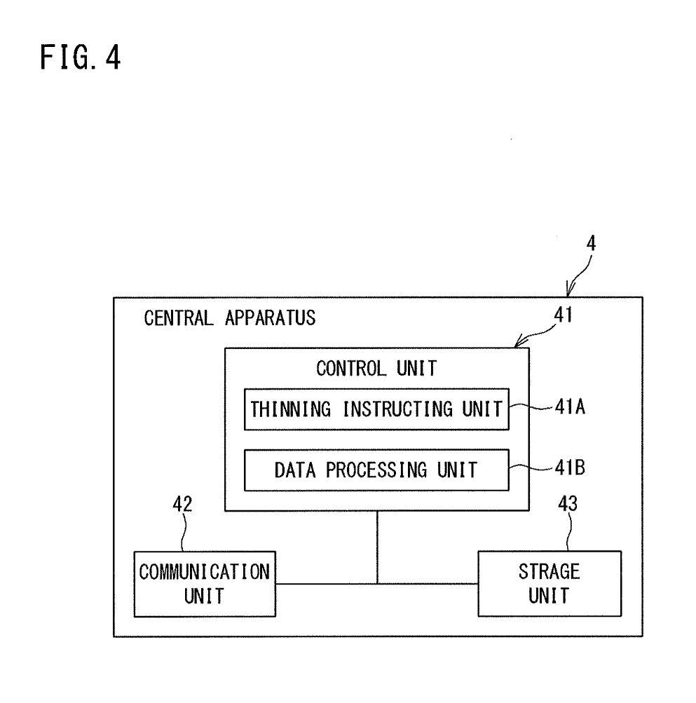

FIG. 4 is a block diagram showing a configuration of the central apparatus 4.

As shown in FIG. 4, the central apparatus 4 of the embodiment includes a control unit 41, a communication unit 42, and a strage unit 43.

The control unit 41 of the central apparatus 4 is composed of a workstation (WS), a personal computer (PC), or the like. The control unit 41 comprehensively performs, for example, collection, processing, and recording of various types of information S3 to S6 which are uplink-transmitted from roadside wireless devices 2 in its control area, and signal control and information provision based on the information S3 to S6.

Specifically, the control unit 41 of the central apparatus 4 can perform, on the traffic signal units 1 at the intersections Ji belonging to the control area, “route control” where a group of traffic signal units 1 on the same road is controlled, “wide area control (plane control)” where the route control is extended to a road network, etc.

The communication unit 42 of the central apparatus 4 is a communication interface that performs communication using the communication line 7. The communication unit 42 performs downlink transmission of a signal control instruction S1 and traffic information S2 and uplink reception of execution information S3, vehicle data S4, detection information S5, and thinning information S6.

The control unit 41 of the central apparatus 4 can perform the above-described route control and wide area control, using uplink information transmitted from the roadside wireless devices 2 at the respective intersections Ji.

In addition, the control unit 41 downlink-transmits a signal control instruction S1 every computation cycle of route control, etc. (e.g., 2.5 minutes), and downlink-transmits traffic information S2 every predetermined cycle (e.g., 5 minutes).

The strage unit 43 of the central apparatus 4 is composed of a hard disk, a semiconductor memory, etc., and stores a computer program which is executed by the control unit 41, various types of data received from other wireless communication devices 2 and 3, etc. The computer program can be stored on a recording medium such as a CD-ROM.

The control unit 41 of the central apparatus 4 has, as functional units achieved by executing the above-described computer program, a thinning instructing unit 41A that can output, for example, an instruction on the execution of a thinning process to the roadside wireless devices 2; and a data processing unit 41B that performs a predetermined process based on thinning information S6 received by the communication unit 42.

The thinning instructing unit 41A functions as a thinning execution instructing unit that can output an instruction on the execution of a thinning process, i.e., an instruction on whether to execute a thinning process, to the roadside wireless devices 2.

In addition, the thinning instructing unit 41A also functions as a thinning condition instructing unit that can output an instruction on a thinning condition (described later) to the roadside wireless devices 2.

The data processing unit 41B performs, for example, at least one of the following five processes, based on thinning information S6:

Process 1: Detection of an abnormality in a thinning process

Process 2: Determination as to whether a traffic flow diagnosis process can be performed

Process 3: Calculation of various amounts of traffic

Process 4: Change of the thinning condition

Process 5: Determination as to whether a calculation process for various amounts of traffic can be performed

Process 1 is a process of detecting an abnormality in a thinning process by monitoring whether a roadside wireless device 2 is performing a thinning process normally.

Process 2 is a process of determining whether a process of estimating a cause of traffic jam, etc., can be executed from obtained vehicle data S4.

Process 3 is a process of performing calculation of various amounts of traffic such as the amount of traffic, travel time, traffic jam length, and the like, of vehicles that are the generators of obtained vehicle data S4.

Process 4 is a process of changing the thinning condition according to the processing load of a roadside wireless device 2, etc.

Process 5 is a process of determining whether various amounts of traffic such as the amount of traffic, travel time, traffic jam length, and the like, of vehicles can be calculated from obtained vehicle data S4 whose generators are the vehicles.

Note that the data processing unit 41B may perform processes other than the above-described processes 1 to 5.

<Configuration of the Roadside Wireless Device>

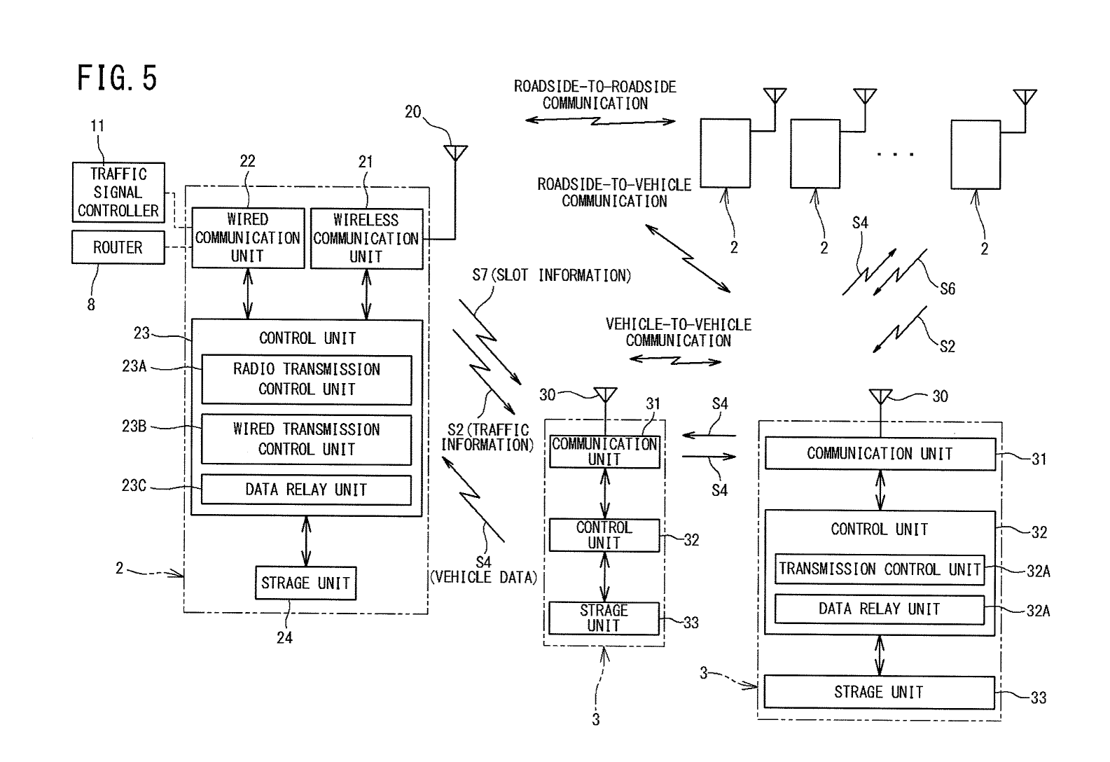

FIG. 5 is a block diagram showing the configurations of a roadside wireless device 2 and an on-vehicle wireless device 3.

The roadside wireless device 2 includes a wireless communication unit 21 having connected thereto an antenna 20 for radio communication; a wired communication unit 22 that performs communication with the central apparatus 4; a control unit 23 composed of, for example, a processor (CPU: Central Processing Unit) that performs those communication control; and a strage unit 24 composed of memory devices such as a ROM and a RAM connected to the control unit 23. The wireless communication unit 21 of the embodiment functions as a receiving unit that receives vehicle data S4.

The strage unit 24 of the roadside wireless device 2 stores a computer program for communication control which is performed by the control unit 23, various types of data received from other wireless communication devices 2 and 3, etc.

The control unit 23 of the roadside wireless device 2 has, as functional units achieved by executing the above-described computer program, a radio transmission control unit 23A that controls the transmission timing of the wireless communication unit 21; a wired transmission control unit 23B that controls the wired communication unit 22; and a data relay unit 23C that performs a relaying process of data received by the communication units 21 and 22.

The data relay unit 23C of the roadside wireless device 2 allows the strage unit 24 to temporarily store traffic information S2 which is received by the wired communication unit 22 from the central apparatus 4, and allows the wireless communication unit 21 to broadcast the traffic information S2.

In addition, the data relay unit 23C allows the strage unit 24 to temporarily store vehicle data S4 which is received by the wireless communication unit 21, and transfers the vehicle data S4 to the central apparatus 4 through the wired communication unit 22 or transfers the vehicle data S4 to another roadside wireless device 2 through the wireless communication unit 21.

The wired transmission control unit 23B of the roadside wireless device 2 outputs an instruction to transmit thinning information S6 to the central apparatus 4, to the wired communication unit 22. Therefore, the wired communication unit 22 of the embodiment functions as a transmitting unit that transmits thinning information S6 to the central apparatus 4.

The thinning information S6 includes, for example, at least one of the following four types of information:

1) Thinning execution information indicating whether a thinning process has been executed

2) Thinning condition information that allows to identify a thinning condition actually used in a thinning process (e.g., a thinning condition or a thinning level)

3) Number-of-vehicle information (number-of-mobile-object information) indicating the number of vehicles that are the generators of pieces of vehicle data S4 obtained by the roadside wireless device 2 before a thinning process

4) Processing load information indicating the processing load of the roadside wireless device 2 (e.g., the CPU usage rate per unit time of the control unit 23)

Note that the thinning information S6 may include information other than the above-described four types of information.

The radio transmission control unit 23A of the roadside wireless device 2 performs radio transmission for a predetermined transmission time period during a time slot T1 with a predetermined slot number j which is assigned to the roadside wireless device 2 (see FIG. 6: the time slot T1 may be hereinafter referred to as a “slot j”), while synchronizing transmission timing with other devices.

The strage unit 24 of the roadside wireless device 2 stores slot information S7 including, for example, the following information a) and b). The slot information S7 is individually set for each roadside wireless device 2.

a) A slot number j being used by the roadside wireless device (j=1 to m) (see FIG. 6)

b) The start time and duration of a first slot T1 with the slot number j (see FIG. 6)

The strage unit 24 of the roadside wireless device 2 stores a transmission time period for the amount of information to be transmitted by the roadside wireless device 2 through radio waves (the amount of transmit data); and a transmission start time thereof. The transmission start time and transmission time period are individually set for each roadside wireless device 2 so as to be present in a time slot T1 assigned to the roadside wireless device 2.

The radio transmission control unit 23A generates a transmit signal with the length of the set transmission time period and allows the wireless communication unit 21 to transmit the transmit signal at the set transmission start time.

The transmission time period of the roadside wireless device 2 may be set to the maximum duration (slot length) of the time slot T1 assigned to the roadside wireless device 2, but taking into account synchronization shifts from other wireless communication devices 2 and 3, the information processing time of the receiving end, etc., it is preferred that the transmission time period be set to be a bit shorter than the slot length, with a predetermine margin (e.g., a guard time on the order of 10 μs).

The transmission time period of the roadside wireless device 2 is adjustable to any time length within the range of the slot length assigned to the roadside wireless device 2, and can be adjusted to a shorter period of time than the slot length.

Of the transmission start time and transmission time period of a transmit signal, the transmission start time may be autonomously generated by the radio transmission control unit 23A of each roadside wireless device 2, based on a start time of a slot j included in slot information S7 of the roadside wireless device 2.

When the radio transmission control unit 23A of the roadside wireless device 2 sends out a communication frame including slot information S7 to a communication area A of the roadside wireless device 2, the radio transmission control unit 23A allows the wireless communication unit 21 to broadcast the communication frame including a timestamp of the current time.

When an on-vehicle wireless device 3 receives the communication frame including the slot information S7 and the timestamp, the on-vehicle wireless device 3 performs radio transmission during a time slot (a second slot T2 of FIG. 6) other than a first slot T1 with a slot number j which is described in the slot information S7, with reference to the current time of the timestamp.

Note that if a main cycle Cm which will be described later (see FIG. 6) is included in slot information S7, then the start time of a slot j and the current time of a timestamp can be represented by relative times in the main cycle Cm. In that case, the number of bits of the slot information S7 can be reduced compared to a case of representing the times by absolute times.

Slot information S7 generated by one roadside wireless device 2 may include at least time information of a slot j used by the roadside wireless device 2.

However, when the roadside wireless device 2 knows of slot information S7 used by another roadside wireless device 2 by roadside-to-roadside communication or communication with the central apparatus 4, the roadside wireless device 2 may transmit the slot information S7 of another roadside wireless device 2 as well.

<Content of Time Slots>

FIG. 6 is a conceptual diagram showing an example of time slots applied to the roadside wireless devices 2.

As shown in FIG. 6, time slots applied to the roadside wireless devices 2 include a first slot T1 and a second slot T2. A total period of the time slots is repeated in certain slot cycles Cs.

The first slot T1 of each slot cycle Cs is a time slot for roadside wireless devices 2. During this time slot, radio transmission by the roadside wireless devices 2 is allowed.

The first slot T1 is provided with a slot number j. The slot number j is cyclically incremented (may be decremented).

The second slot T2 is a time slot for on-vehicle wireless devices 3. This time slot is open for radio transmission by on-vehicle wireless devices 3, and thus, the radio transmission control units 23A of the roadside wireless devices 2 do not perform radio transmission during the second slot T2.

The slot number i gets back to an initial number (j=1 in the example in the drawing) when reaching a predetermined number m. Therefore, when m slot cycles Cs form a main cycle Cm, a first slot T1 with each of the slot numbers i to m occurs once every main cycle Cm.

Note that the time lengths of the cycles Cs and Cm and the total number m of slot cycles Cs can be set by a system operator as appropriate, but in the embodiment, as an example, Cs=10 ms, Cm=100 ms, and m=10.

In FIG. 6, a black filled circle described in each first slot T1 with the slot number j=1 to 3 represents a roadside wireless device 2 whose transmission time period is assigned to that first slot T1 with the slot number j. Therefore, slots 1 and 2 each having a plurality of black filled circles indicate that the transmission time periods of a plurality of roadside wireless devices 2 overlap each other and the slot number j is shared by the plurality of roadside wireless devices 2.

In the example of FIG. 6, the slot 1 is shared by two roadside wireless devices 2 installed at an intersection J1 and an intersection J11, and the slot 2 is shared by three roadside wireless devices 2 installed at an intersection J2, an intersection J9, and an intersection J10.

<Configuration of the On-Vehicle Wireless Device>

Referring back to FIG. 5, the on-vehicle wireless device 3 includes a communication unit 31 connected to an antenna 30 for radio communication; a control unit 32 composed of, for example, a processor that performs communication control on the communication unit 31; and a strage unit 33 composed of memory devices such as a ROM and a RAM connected to the control unit 32.

The strage unit 33 of the on-vehicle wireless device 3 stores a computer program for communication control which is performed by the control unit 32, various types of data received from other wireless communication devices 2 and 3, etc.

The control unit 32 of the on-vehicle wireless device 3 is a control unit that allows the communication unit 31 to perform radio communication by a carrier sense system for vehicle-to-vehicle communication, and does not have a communication control function by a time division multiplexing system like the roadside wireless device 2.

Therefore, the communication unit 31 of the on-vehicle wireless device 3 senses a reception level of a predetermined carrier frequency at all times, and is configured not to perform radio transmission when the value of the reception level is greater than or equal to a given threshold value, and to perform radio transmission only when the value reaches less than the threshold value.

The control unit 32 of the on-vehicle wireless device 3 has, as functional units achieved by executing the above-described computer program, a transmission control unit 32A that controls the radio transmission timing of the communication unit 31; and a data relay unit 32B that performs a relaying process of data received by the communication unit 31.

The transmission control unit 32A of the on-vehicle wireless device 3 identifies a time slot for radio transmission that is allowed for the on-vehicle wireless device 3, according to a start time included in slot information S7 obtained from a roadside wireless device 2 and the slot information S7, and allows the communication unit 31 to perform radio transmission only during this time slot.

Namely, the transmission control unit 32A extracts slot information S7 and a timestamp which are generated by a roadside wireless device 2, from a communication frame directly received from the roadside wireless device 2 or received via another on-vehicle wireless device 3.

Then, the transmission control unit 32A allows the communication unit 31 to perform radio transmission by a carrier sense system only during a time slot (a second slot T2 of FIG. 6) other than a time slot T1 with a predetermined slot number i which is described in the slot information S7, with reference to the time of the timestamp.

The transmission control unit 32A of the on-vehicle wireless device 3 stores vehicle data S4 including the time information, location information, direction, speed, and the like, of a vehicle 5 (the on-vehicle wireless device 3) in a communication frame, and radio-transmits the communication frame by broadcast through the communication unit 31.

The data relay unit 32B of the on-vehicle wireless device 3 can perform a relaying process where predetermined data is extracted from a communication frame received by the communication unit 31 and a transmission frame including the extracted data is transmitted by the communication unit 31.

For example, the data relay unit 32B extracts traffic information S2 or vehicle data S4 of another vehicle 5 from a communication frame received from a roadside wireless device 2, generates a communication frame including the extracted data, and allows the communication unit 31 to transmit the communication frame.

In addition, when a communication frame received from a roadside wireless device 2 or a communication frame received from another vehicle 5 includes slot information S7, the data relay unit 32B extracts the slot information S7 and temporarily stores the slot information S7 in the strage unit 33, and also stores the slot information S7 in a communication frame and allows the communication unit 31 to transmit the communication frame.

The control unit 32 of the on-vehicle wireless device 3 can perform safe driving support control that avoids right turn collisions, intersection collisions, etc., based on the locations, speeds, directions, and the like, of vehicles 5 which are included in vehicle data S4 directly received from other vehicles 5 (on-vehicle wireless devices 3) or in vehicle data S4 of other vehicles 5 received from roadside wireless devices 2.

<Frame Format for Vehicle-To-Vehicle Communication>

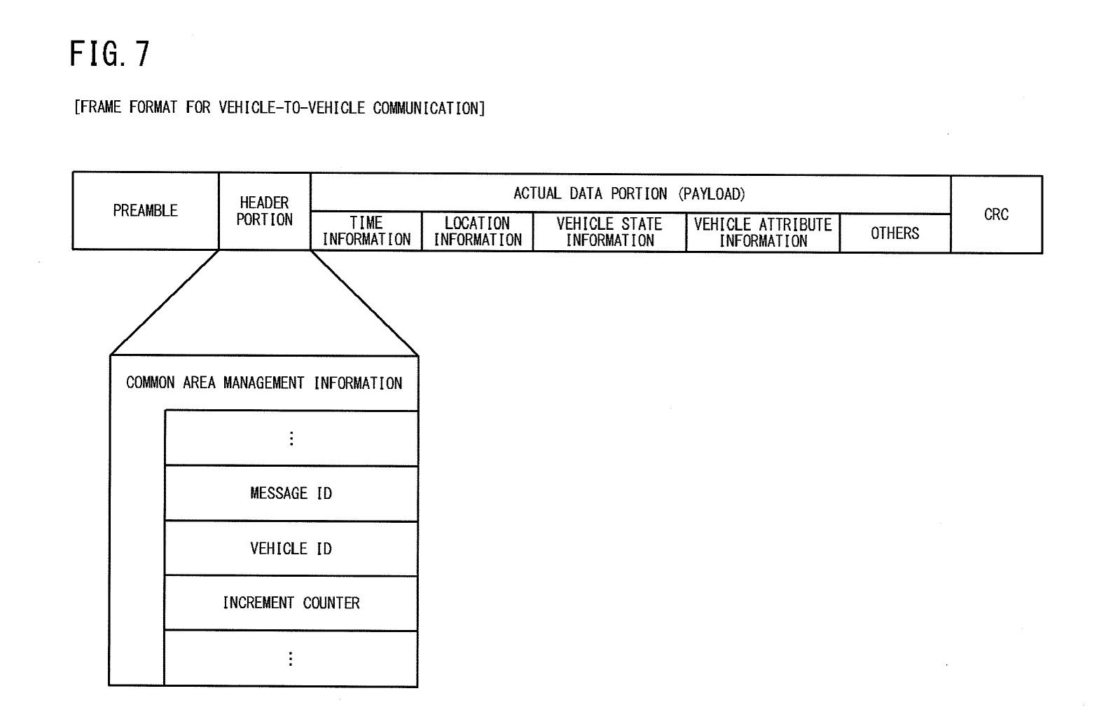

FIG. 7 is a diagram showing a frame format of a communication frame used for vehicle-to-vehicle communication.

The frame format of FIG. 7 is a frame format conforming to the “700 MHz BAND INTELLIGENT TRANSPORT SYSTEMS—Experimental Guideline for Inter-vehicle Communication Messages ITS FORUM RC-013 Ver. 1.0” (established on Mar. 31, 2014).

The above-described standard stipulates a “common area” which is obliged to be stored in all communication frames (the same as the “messages” referred to in the standard) and a “free area” which is arbitrarily stored. The free area can be freely defined by a user, and thus, in the frame format of FIG. 7, only portions related to the common area are described.

As shown in FIG. 7, a communication frame includes a “preamble”, a “header portion”, an “actual data portion (payload)”, and a “CRC (Cyclic Redundancy Check)”.

The “header portion” includes “common area management information” which is basic management information of data to be stored in the common area. The “common information management information” includes a “message ID”, a “vehicle ID”, an “increment counter”, and the like.

The “message ID” stores an identification value of the type of the communication frame (message). The “vehicle ID” stores an identification value of a vehicle 5 which is the generator of vehicle data S4. The “increment counter” stores a number value indicating the transmission order of the communication frame.

When an on-vehicle wireless device 3 transfers a communication frame by vehicle-to-vehicle communication, the on-vehicle wireless device 3 increments a value stored in an increment counter of the communication frame by one for each transfer.

Therefore, the receiving end of the communication frame can determine, by the number value of the increment counter, whether the received communication frame is a communication frame directly received from the generator or a communication frame indirectly received by a transfer.

The receiving end of communication frames can also determine the identicalness of data content of the received communication frames, based on both the identification value of a vehicle ID (hereinafter, also referred to as a “vehicle ID value”) and the number value of an increment counter (hereinafter, also referred to as a “counter value”).

Namely, when two communication frames with the same vehicle ID value and the same counter value are received, the receiving end of the communication frames can determine that the two communication frames have the same data content.

The “actual data portion” includes “time information”, “location information”, “vehicle state information”, “vehicle attribute information”, and “other information”.

The “time information” stores a time value at which the vehicle 5 fixes data content to be stored in the communication frame. The “location information” stores values such as a latitude, a longitude, and an altitude associated with the time value. The “vehicle state information” stores values such as a vehicle speed, a vehicle azimuth angle, and longitudinal acceleration associated with a time point value. The “vehicle attribute information” stores identification values such as a vehicle size type (a full-size car, a standard-size car, or the like), a vehicle use type (a private vehicle, an emergency vehicle, or the like), a vehicle width, and a vehicle length.

The “other information” stores optional information such as detailed information or supplementary information about the information stored in the common area. Therefore, storing of data in the other information is arbitrary.

For example, information to be stored in the other information includes “optional location information” which is optional information of the “location information”. The optional location information stores the value of a reliability index (the major and minor axes of a horizontal error ellipse, etc.) of a location obtained by the vehicle 5 through GPS. The receiving end of the communication frame can determine the accuracy of the location information by the magnitude of the index value.

<Transmission Format for Uplink Transmission>

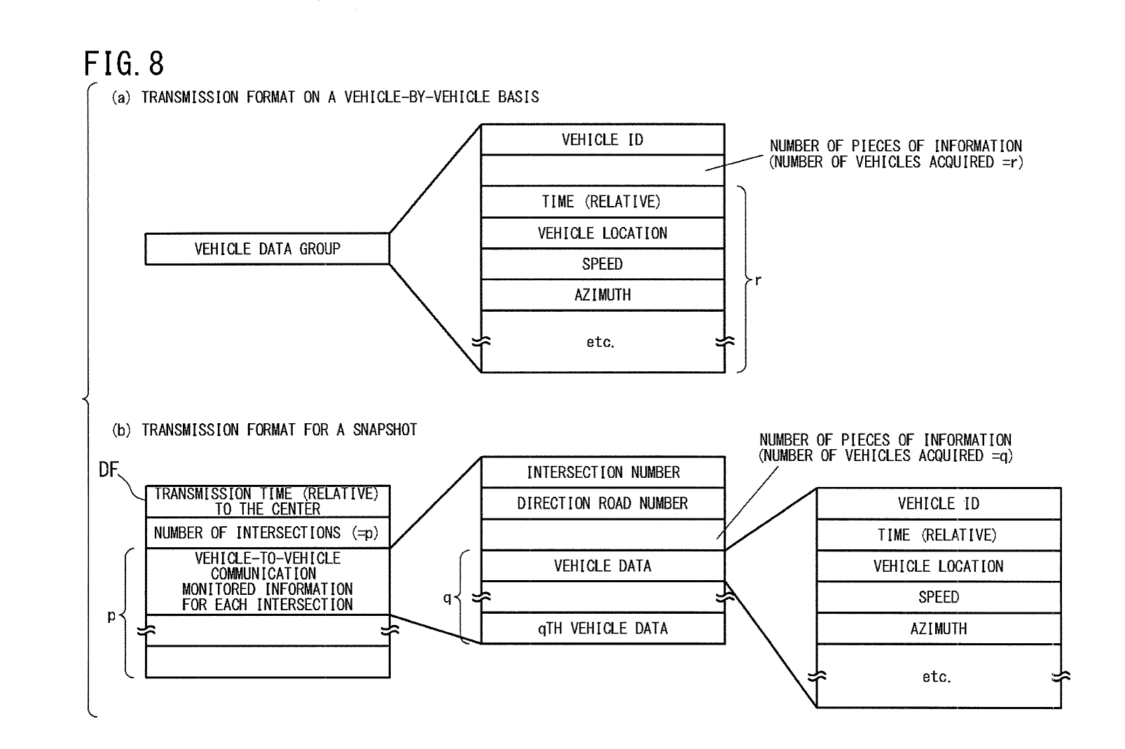

FIGS. 8(a) and 8(b) are diagrams showing the data formats of vehicle data S4 used upon uplink transmission. Specifically, FIG. 8(a) shows a “transmission format on a vehicle-by-vehicle basis” and FIG. 8(b) shows a “transmission format for a snapshot”.

A control unit 23 (specifically, a data relay unit 23C) of a roadside wireless device 2 converts vehicle data S4 obtained through reception of radio waves by vehicle-to-vehicle communication into a data format for uplink transmission, using either one of the above-described transmission formats, and relays the vehicle data S4 to the central apparatus 4.

Here, when a roadside wireless device 2 that has directly obtained vehicle data S4 from a vehicle 5 is a “roadside wireless device X” and a roadside wireless device 2 that performs roadside-to-roadside communication with the roadside wireless device X by radio is a “roadside wireless device Y”, the following two routes are assumed for uplink transmission of the vehicle data S4:

Route 1: Roadside wireless device X→communication lines→central apparatus

Route 2: Roadside wireless device X→roadside wireless device Y→communication lines→central apparatus

In the case of route 1, the roadside wireless device X performs the above-described data format conversion.

In the case of route 2, the following cases are considered: a case (first case) in which the roadside wireless device X performs data format conversion and the roadside wireless device Y does not perform data format conversion, and a case (second case) in which the roadside wireless device X in route 2 does not perform data format conversion but the roadside wireless device Y performs data format conversion.

The first case is a case in which the roadside wireless device 2 having directly obtained the vehicle data S4 from the vehicle 5 converts the data format.

The second case is a case in which the data format is not converted in roadside-to-roadside communication, but the roadside wireless device 2 that sends out the vehicle data S4 to a communication line 7 converts the data format.

It is assumed that the roadside wireless devices 2 of the embodiment are wireless communication devices that can handle both the first and second cases.

The “transmission format on a vehicle-by-vehicle basis” of FIG. 8(a) is a system in which obtained pieces of vehicle data S4 are compiled on a per vehicle ID basis. Namely, the control unit 23 of the roadside wireless device 2 chronologically rearranges a plurality of pieces of vehicle data S4 with the same vehicle ID which are obtained within a predetermined compilation period (e.g., one to several seconds), in order of pieces of time information thereof and thereby generates a “vehicle data group” shown in the drawing.

The “vehicle data group” includes data such as a “vehicle ID”, the “number of pieces of information” (it is assumed that the number of vehicles acquired=r), a “time (relative)”, a “vehicle location”, a “speed”, and “azimuth” in this order from the top.

The “number of pieces of information” refers to the number of pieces of vehicle data S4 for a specific vehicle ID whose time values (the value of “time information” of FIG. 7) are within the compilation period. In the example shown in the drawing, since the number of pieces of information =r, the vehicle data group includes r “times (relative)” and pieces of data associated with the r “times (relative)”.

The “time (relative)” is an area that stores the time value of the vehicle data S4. Storage areas following this area, such as a “vehicle location”, a “speed”, and an “azimuth”, are areas that respectively store, for example, the values of location information, speed, and azimuth associated with the time value.

When the control unit 23 of the roadside wireless device 2 generates a vehicle data group using the transmission format on a vehicle-by-vehicle basis, the control unit 23 stores the generated vehicle data group in a communication frame that is destined for the central apparatus 4 and that conforms to a communication protocol used for roadside-to-roadside communication or used by the communication lines 7.

The communication unit 21, 22 of the roadside wireless device 2 uplink-transmits the above-described communication frame to another roadside wireless device 2 or the communication line 7.

The “transmission format for a snapshot” of FIG. 8(b) is a system in which a data file DF of pieces of vehicle data S4 obtained at the time point of uplink transmission to the central apparatus 4 is adopted as it is as transmit data to the central apparatus 4.

The data file DF in the example shown in the drawing includes a “transmission time (relative) to the center”, the “number of intersections” (here, it is assumed that the number of intersections=p), and “vehicle-to-vehicle communication monitored information for each intersection” (which may be hereinafter abbreviated as “monitored information”) in this order from the top.

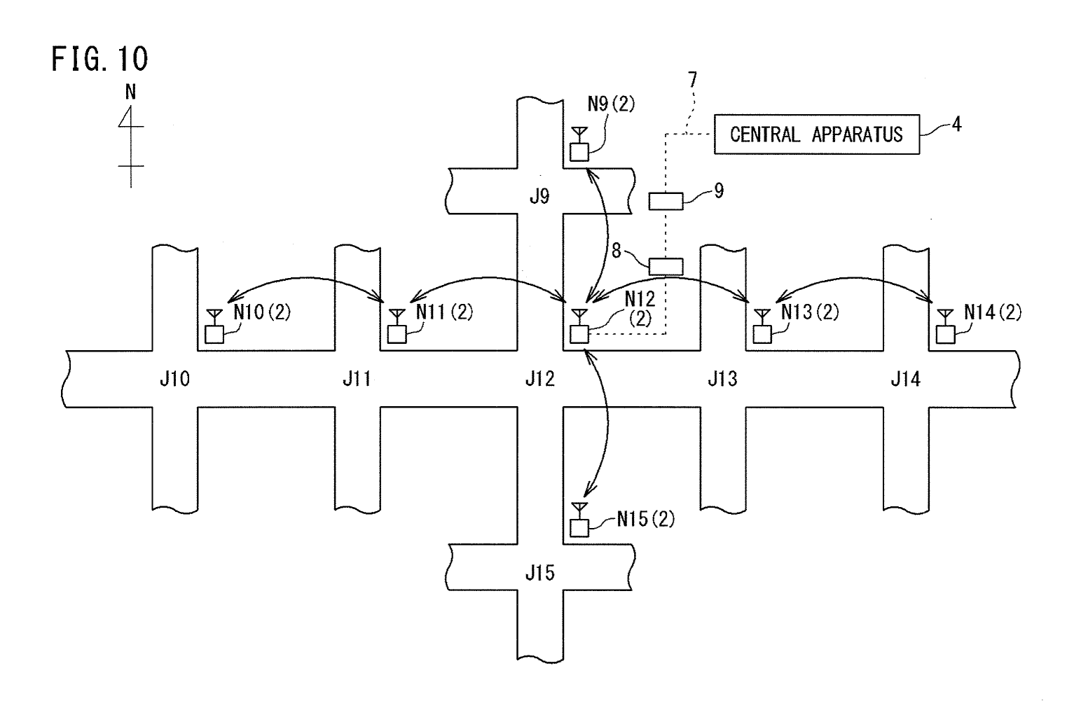

Note that the example of FIG. 8(b) assumes a case (see FIG. 10) in which one roadside wireless device 2 functions as a “master station” and uplink-transmits pieces of monitored information which are collected from other roadside wireless devices 2 (slave stations) by roadside-to-roadside communication, to the central apparatus 4.

The “transmission time (relative) to the center” refers to the transmission time of the data file DF. The “number of intersections” refers to the number of intersections where the roadside wireless device 2 serving as the master station has obtained pieces of monitored information by roadside-to-roadside communication. In the example shown in the drawing, the number of intersections=p, and thus, the data file DF includes pieces of monitored information for the p intersections.

The “vehicle-to-vehicle communication monitored information for each intersection” includes an “intersection number”, a “direction road number”, the “number of pieces of information” (it is assumed that the number of vehicles acquired=q), and q pieces of “vehicle data” in this order from the top.

The “intersection number” is an area that stores an identification value of an intersection where the monitored information is acquired. The “direction road number” is an area that stores an identification value indicating which direction's flow-in or flow-out road the road connected to the intersection is. The “number of pieces of information” is an area that stores the number of pieces of vehicle data S4 obtained at the intersection and on the direction road. In the example shown in the drawing, the number of information=q, and thus, the monitored information includes q pieces of vehicle data S4.

When the control unit 23 of the roadside wireless device 2 adopts the transmission format for a snapshot, the control unit 23 stores a data file DF obtained at the time point of uplink transmission in a communication frame that is destined for the central apparatus 4 and that conforms to a communication protocol used for roadside-to-roadside communication or used by the communication line 7.

The communication unit 21, 22 of the roadside wireless device 2 uplink-transmits the above-described communication frame to another roadside wireless device 2 or the communication line. Note that in this transmission format, the control unit 23 uplink-transmits a data file DF every predetermined period of time (e.g., one to several seconds).

In the transmission formats of FIGS. 8(a) and 8(b), by storing, as a data value stored in each data area, a difference value from the last value, the amount of data to be uplink-transmitted can be made compact.

In addition, data that has not been changed from the last transmission timing may not be transmitted and may be uplink-transmitted at a time point when a change has occurred. In this case, elapsed time (counter value) from before the change may be included as an information item.

<Thinning Process by the Data Relay Unit >

The control unit 23 (specifically, the data relay unit 23C) of the roadside wireless device 2 can perform at least one of the following first and second processes (hereinafter, collectively referred to as “thinning processes”) on obtained vehicle data S4.

First process: A process in which the amount of obtained vehicle data S4 is reduced and then the vehicle data S4 is relayed

Second process: A process in which some or all of an obtained plurality of pieces of vehicle data S4 are discarded without being relayed

The first process is a process of reducing the amount of data in units of vehicle data by removing some or all of data included in one piece of vehicle data S4.

This process includes, for example, a process in which in the frame format of FIG. 7, without removing the “time information” and the “location information” in the actual data portion, only minimum necessary data usable as probe data is left, and the “vehicle state information”, the “vehicle attribute information”, and the “other information” are removed. However, all information in the actual data portion may be removed.

The second process is a process of reducing the amount of vehicle data S4 in units of groups by discarding some or all of pieces of vehicle data S4 in a group of pieces of vehicle data S4 obtained during a predetermined period or a predetermined number of pieces of vehicle data S4, without relaying them.

This process includes, for example, a process in which a cycle period with a predetermined cycle (e.g., several seconds) is defined and from among a group where pieces of time information of pieces of vehicle data S4 are included in a specific cycle period, some or all of the pieces of vehicle data S4 are discarded at a predetermined ratio.

The control unit 23 of the roadside wireless device 2 performs at least one of the above-described first and second processes.

Note that although the above-described description of the thinning processes assumes a case in which a target of the thinning processes is vehicle data S4, the control unit 23 of the roadside wireless device 2 can also perform the same thinning process on data information obtained from pedestrians' portable terminals.

The control unit 23 of the roadside wireless device 2 may perform a predetermined compression process on remaining uplink information to be relayed after a thinning process.

By doing so, the amount of data to be uplink-transmitted to the central apparatus 4 is further reduced, and thus, the overload of the communication lines 7 can be more effectively suppressed.

<Thinning Condition>

The control unit 23 of the roadside wireless device 2 performs a thinning process on vehicle data S4, for example, based on thinning conditions of a plurality of stages.

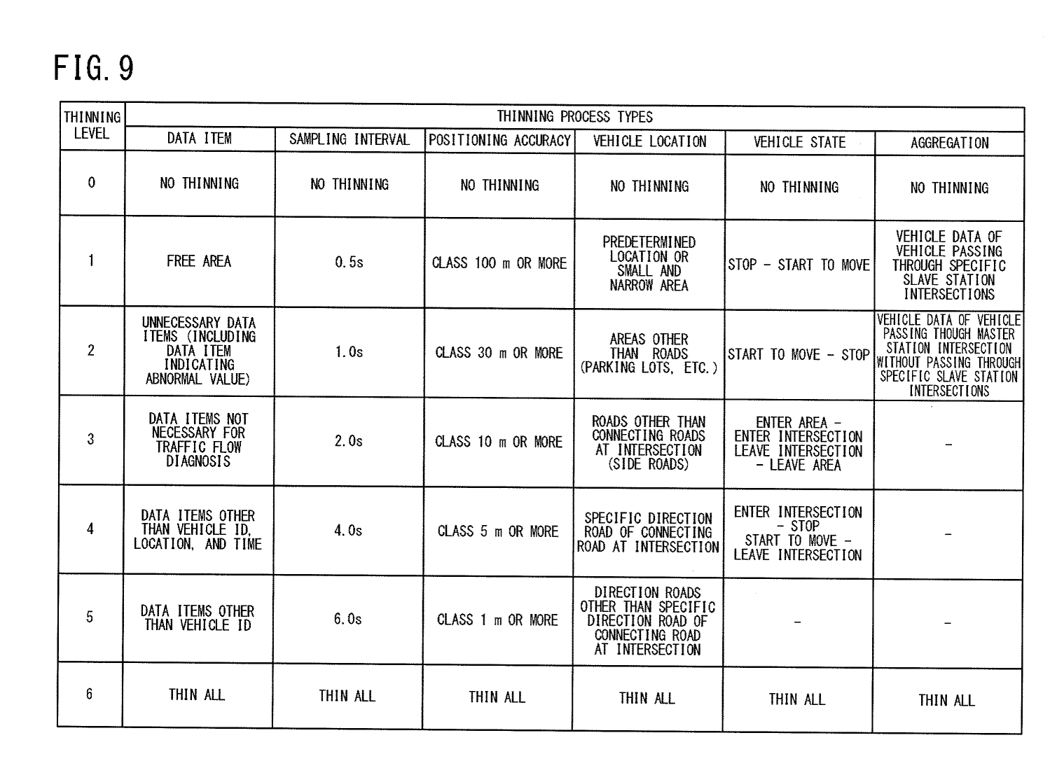

FIG. 9 exemplifies a plurality of types (here, six types) of thinning processes, and each thinning process has different thinning conditions for different thinning levels of a plurality of stages. The plurality of thinning conditions of each thinning process have conditional content where the amount of thinning increases gradually as the thinning level gets higher.

Note that the plurality of thinning conditions may have processing content where the amount of thinning increases gradually as the thinning level gets lower.

Note also that although the thinning level in the embodiment gets higher as the value of the level gets larger, the thinning level may get higher as the value of the level gets smaller.

The above-described plurality of thinning conditions of each thinning process can be set by any of the following first to third settings:

First setting: A thinning condition determined in advance on the roadside wireless device 2 is set

Second setting: A thinning condition is set by a communication instruction from the central apparatus 4

Third setting: The roadside wireless device 2 dynamically changes and sets a thinning condition

In the case of the first setting, a thinning condition is stored in advance in the strage unit 24 of the roadside wireless device 2. Details will be described in a first embodiment which will be described later.

In the case of the second setting, the thinning instructing unit 41A in the control unit 41 of the central apparatus 4 outputs an instruction on the execution of a thinning process or an instruction on a thinning condition, to the roadside wireless device 2. Details will be described in a second embodiment which will be described later.

In the case of the third setting, the data relay unit 23C in the control unit 23 of the roadside wireless device 2 dynamically changes and sets a thinning condition, according to the amount of vehicle data S4 collected from an on-vehicle wireless device 3, the processing load conditions of the roadside wireless device 2, etc. Details will be described in a third embodiment which will be described later.

The control unit 23 of the roadside wireless device 2 performs, for example, any one type of thinning process shown in FIG. 9. Specifically, when a “data item” thinning process is performed, the control unit 23 sets the thinning level of the “data item” thinning process to “1” or more (e.g., “2”) and sets other thinning processes to “no thinning” (thinning level=“0”).

Note that the control unit 23 may perform two or more types of thinning processes. In this case, the control unit 23 may set different thinning levels for different thinning processes. For example, the thinning level of a “data item” thinning process may be set to “1”, the thinning level of a “sampling interval” thinning process may be set to “2”, and other thinning processes may be set to “no thinning” (thinning level=“0”).

FIG. 9 exemplifies six types of thinning processes: “data item”, “sampling interval”, “positioning accuracy”, “vehicle location”, “vehicle state”, and “aggregation”. Each thinning process exemplifies different thinning conditions for a plurality of different thinning levels (here, seven thinning levels “0” to “6”). The content of each thinning condition will be described below with reference to FIG. 9.

Note that since the thinning conditions for the thinning levels “0” of the respective thinning processes are all set to “no thinning” and the thinning conditions for the thinning levels “6” are all set to “thin all”, in each thinning process, the thinning levels “1” to “5” will be described and description of the thinning levels “0” and “6” is omitted.

<Data Item>

A “data item” thinning process is such that some or all of a plurality of data items included in a data format of vehicle data S4 are removed, by which the amount of the vehicle data S4 to be uplink-transmitted is reduced.

Hence, in each thinning condition for the “data item”, data items serving as removal targets among the plurality of data items included in the data format of the vehicle data S4 are set as conditional content. The amount of data of data items serving as removal targets in each thinning condition is set so as to increase gradually as the thinning level gets higher (here, as the value of the level gets larger).

Specifically, in the case of the thinning level “1”, all data items in a free area (about 60 B) of the above-described data format are set as removal target data items. Since the free area is an area where the on-vehicle wireless device 3 side can freely set data items, and is less likely to be used for traffic control, etc., the free area is set as the first removal target of the vehicle data S4.

In the case of the thinning level “2”, in addition to the free area of the vehicle data S4, unnecessary data items (about 40 B) are set as removal targets. The unnecessary data items include, for example, a data item composed of intersection information. This is because the intersection information is known information that the central apparatus 4 also has, and thus does not need to be relayed to the central apparatus 4 from the roadside wireless device 2.

In addition, the unnecessary data items also include a data item indicating an abnormal value. For example, when a clock mounted on a vehicle that is the generator of vehicle data S4 is significantly slow, time information included in the vehicle data S4 of the vehicle is a data item indicating an abnormal value. In addition, all data items of vehicle data S4 of a vehicle that travels abnormally out of a normal traffic flow are data items indicating abnormal values.

In the case of the thinning level “3”, in addition to the free area and unnecessary data items of the vehicle data S4, data items (about 20 B) that are not necessary when the central apparatus 4 diagnoses a traffic flow are also set as removal targets.

In the case of the thinning level “4”, data items including the vehicle ID, location information, and time information of the vehicle data S4 (about 16 B) remain, and all other data items are set as removal targets.

In the case of the thinning level “5”, all data items excluding the vehicle ID (about 4 B) of the vehicle data S4 are set as removal targets. Note that the reason that only the vehicle ID of the vehicle data S4 remains is to grasp the number of vehicles flowing into the intersection.

<Sampling Interval>

A “sampling interval” thinning process is such that a sampling interval (time interval) at which vehicle data S4 is uplink-transmitted is increased, by which pieces of vehicle data S4 received by the roadside wireless device 2 during the sampling interval are discarded.

Hence, in each thinning condition for the “sampling interval”, the sampling interval serving as a thinning target is set as conditional content. The sampling interval for each thinning condition is set so as to increase gradually as the thinning level gets higher.

Specifically, the sampling interval for the case of the thinning level “1” is set to 0.5 seconds. In this case, since vehicle data S4 is uplink-transmitted every 0.5 seconds, pieces of vehicle data S4 received during this period of 0.5 seconds are discarded.

In the case of the thinning levels “2” to “5”, their respective sampling intervals are set to 1.0 second, 2.0 seconds, 4.0 seconds, and 6.0 seconds.

<Positioning Accuracy>

A “positioning accuracy” thinning process is such that the level of positioning accuracy of a vehicle that is the generator of vehicle data S4 is used as a transmission condition of the vehicle data S4, by which vehicle data S4 that does not meet the transmission condition is discarded. The level of positioning accuracy of a vehicle can be obtained from information indicating the positioning accuracy of the vehicle which is included in vehicle data S4.

Hence, in each thinning condition for the “positioning accuracy”, the positioning accuracy serving as the transmission condition is set as conditional content. The level of positioning accuracy (hereinafter, referred to as target positioning accuracy) for each thinning condition is set so as to increase gradually as the thinning level gets higher.

Specifically, in the case of the thinning levels “1” to “5”, their respective levels of target positioning accuracy are represented using an accuracy error, and set to class 100 m or more, class 30 m or more, class 10 m or more, class 5 m or more, and class 1 m or more.

Here, the “class 100 m or more” refers to that it includes the levels of positioning accuracy higher than (accuracy errors smaller than) class 100, and includes class 30 m or more, class 10 m or more, class 5 m or more, and class 1 m or more.

Therefore, the “class 30 m or more” includes class 10 m or more, class 5 m or more, and class 1 m or more, and the “class 10 m or more” includes class 5 m or more and class 1 m or more. Then, the “class 5 m or more” includes class 1 m or more.

<Vehicle Location>

A “vehicle location” thinning process is such that, when the location of a vehicle that is the generator of vehicle data S4 is included in a predetermined region, the vehicle data S4 obtained by the roadside wireless device 2 from the vehicle is discarded. The location of the vehicle can be obtained from location information included in the vehicle data S4.

Hence, in each thinning condition for the “vehicle location”, the size of the predetermined region serving as a thinning target (hereinafter, referred to as a target predetermined region) is set as conditional content. The size of the predetermined region for each thinning condition is set so as to increase gradually as the thinning level gets higher.

Specifically, at the thinning level “1”, a predetermined location or a predetermined small and narrow area is set as the target predetermined region.

In the case of the thinning level “2”, areas other than roads, such as parking lots, are added to the target predetermined region with the thinning level “1”.

In the case of the thinning level “3”, roads excluding connecting roads at the intersection (e.g., side roads) are added to the target predetermined region with the thinning level “2”.

In the case of the thinning level “4”, a specific direction road of a connecting road at the intersection (e.g., a flow-out road of a sub-road) is added to the target predetermined region with the thinning level “3”.

In the case of the thinning level “5”, direction roads other than the above-described specific direction road of the connecting road at the intersection are added to the target predetermined region with the thinning level “4”.

Note that although in the above-described thinning process, the fact that the location of a vehicle is included in the predetermined region is used as the transmission condition of vehicle data S4, the fact that the location of a vehicle is not included in the predetermined region may be used as the transmission condition of vehicle data S4. In this case, the size of the predetermined region serving as the transmission condition for each thinning condition may be set so as to decrease gradually as the thinning level gets higher.

<Vehicle State>

A “vehicle state” thinning process is such that vehicle data S4 obtained by the roadside wireless device 2 from a vehicle that is the generator of the vehicle data S4 in a predetermined number of event sections of the vehicle is discarded. An event of the vehicle can be obtained from vehicle state information and location information which are included in the vehicle data S4.

Hence, in each thinning condition for the “vehicle state”, the number of the above-described event sections (hereinafter, referred to as target event sections) is set as conditional content. The number of event sections for each thinning condition is set so as to increase gradually as the thinning level gets higher.

Specifically, in the case of the thinning level “1”, a section from a time point when the vehicle is stopped to a time point when the vehicle starts to move, i.e., a section where the vehicle is being stopped, is set as the first target event section. The reason that the section where the vehicle is being stopped is thus set as a target event section is because even if vehicle data S4 obtained from the vehicle while the vehicle is being stopped is discarded, by assuming that the vehicle is not moving, the behavior of the vehicle can be complemented.

In the case of the thinning level “2”, a section from a time point when the vehicle has started to move to a time point when the vehicle stops, i.e., a section where the vehicle is traveling, is set as the second target event section. The reason that the section where the vehicle is traveling is thus set as a target event section is because even if vehicle data S4 received from the vehicle while the vehicle is traveling is discarded, by assuming that the vehicle is moving at a constant velocity, the behavior of the vehicle can be complemented.

In the case of the thinning level “3”, a section from a time point when the vehicle has entered a communication area A (see FIG. 3) of the roadside wireless device 2 to a time point when the vehicle enters an intersection and a section from a time point when the vehicle has left the intersection to a time point when the vehicle leaves the communication area A are set as the third target event sections.

In the case of the thinning level “4”, a section from a time point when the vehicle has entered the intersection until the vehicle stops and a section from a time point when the vehicle has started to move to a time point when the vehicle leaves the intersection are set as the fourth target event sections.

Note that in this thinning process, a target event section for the case of the thinning level “5” is not set, but a target event section may be set for the case of this thinning level, too.

Note also that four types of thinning conditions with the thinning levels “1” to “4” can be set to any thinning level as long as the thinning level gets higher step-by-step within the range of the thinning levels “1” to “5”.

For example, the thinning levels of the above-described four types of thinning conditions may be set to “2” to “5”, or may be set to “1”, “2”, “3”, and

<Aggregation>

An “aggregation” thinning process is used for an ITS radio system (communication system) including a plurality of communication nodes Ni, each composed of a roadside wireless device 2 that performs roadside-to-roadside communication and roadside-to-vehicle communication by radio, as shown in FIG. 10.

The ITS radio system shown in FIG. 10 includes a plurality of communication nodes N9 to N15 corresponding to intersections J9 to J15, respectively. Each communication node Ni is composed of a roadside wireless device 2 and can perform roadside-to-roadside communication with its adjacent communication nodes Ni.

Of the plurality of communication nodes N9 to N15, the communication node N12 is specified as a “master station” that is connected to the central apparatus 4 by a communication line 7, and other communication nodes N9 to N11 and N13 to N15 are specified as “slave stations”.

Therefore, pieces of vehicle data S4 obtained from vehicles 5 by the slave station communication nodes N9 to N11 and N13 to N15 are collected at the master station communication node N12 by roadside-to-roadside communication.

The master station communication node N12 uplink-transmits those pieces of vehicle data S4 collected from the slave station communication nodes N9 to N11 and N13 to N15 and those pieces of vehicle data S4 obtained on its own all at once to the central apparatus 4.

In FIGS. 9 and 10, the “aggregation” thinning process is such that upon uplink transmission of vehicle data S4 aggregated at the master station communication node N12, when a vehicle that is the generator of pieces of vehicle data S4 transferred from slave station communication nodes is traveling a predetermined number of traveling routes (moving routes), the pieces of vehicle data S4 are discarded. The traveling route of the vehicle can be obtained from time information and location information which are included in the vehicle data S4.

Hence, in each thinning condition for the “vehicle state”, the number of the above-described traveling routes (hereinafter, referred to as target traveling routes) is set as conditional content. The number of traveling routes for each thinning condition is set so as to increase gradually as the thinning level gets higher.

Specifically, in the case of the thinning level “1”, a traveling route where a vehicle passes through slave station intersections where specific slave station communication nodes are installed is set as a target traveling route.

For example, in FIG. 10, a traveling route (first traveling route) where a vehicle passes through the intersection J9 on the north side and the intersection J15 on the south side where the slave station communication nodes N9 and N15 are installed is set as the first target traveling route.

In this case, a traveling route of a vehicle that is the generator of pieces of vehicle data S4 received by the slave station communication nodes N9 and N15 in communication areas of the respective slave stations corresponds to a traveling route where the vehicle passes through the intersections J9 and J15, i.e., the first traveling route serving as a thinning target. Therefore, the pieces of vehicle data S4 of the vehicle are transferred to the master station communication node N12 from the communication nodes N9 and N15 and then discarded without being uplink-transmitted.

In the case of the thinning level “2”, a traveling route where a vehicle passes through a master station intersection where the master station communication node is installed, without passing through specific slave station intersections is set as the second target traveling route.

For example, in FIG. 10, a traveling route (second traveling route) where a vehicle passes through the intersection J12 where the master station communication node N12 is installed, without passing through either of the intersection J11 on the west side and the intersection J13 on the east side where the slave station communication nodes N11 and N13 are installed is added to the target traveling route with the thinning level “1”.

In this case, vehicle data S4 of a vehicle traveling the second traveling route is obtained by the communication node N12 in a communication area of its station, but is not obtained by the communication nodes N11 and N13 in communication areas of their stations. Hence, the vehicle data S4 of the vehicle traveling the second traveling route is not transferred from the slave station communication nodes N11 and N13, but is obtained by the master station communication node N12 on its own.

Therefore, vehicle data S4 that is not transferred from the slave station communication nodes N11 and N13 but is obtained by the master station communication node N12 on its own is discarded without being uplink-transmitted.

By this, vehicle data S4 transferred from the slave station communication nodes N11 and N13 to the master station communication node N12 can be relayed to the central apparatus 4 on a priority basis.

Therefore, the central apparatus 4 can handle pieces of vehicle data S4 of the same vehicle 5 as one piece of probe data collected over a long section from the intersection J11 (J13) to the intersection J12 on the central side.

Note that in this thinning process, a thinning condition for the case of the thinning levels “3” to “5” is not set, but a thinning condition may be set for the case of these thinning levels, too.

Note also that two types of thinning conditions with the thinning levels “1” and “2” can be set to any thinning level as long as the thinning level gets higher step-by-step within the range of the thinning levels “1” to “5”.

For example, the thinning levels of the above-described two types of thinning conditions may be set to “3” and “4”, or may be set to “2” and “5”.

### First Embodiment

<Roadside Wireless Device of a First Embodiment>

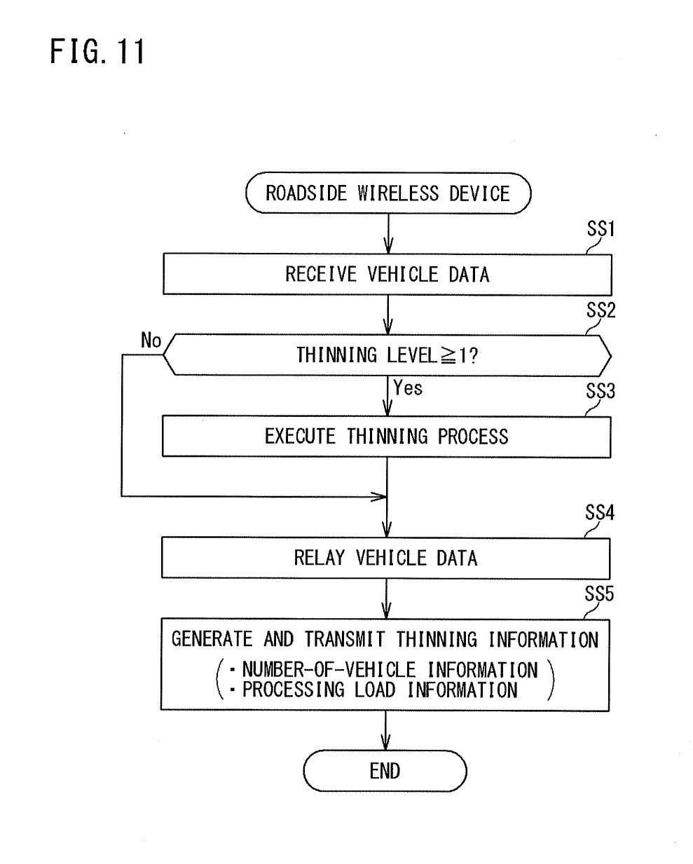

FIG. 11 is a flowchart showing an example of a data relaying process performed by a control unit 23 of a roadside wireless device 2 of a first embodiment.

The roadside wireless device 2 of the first embodiment performs a thinning process based on a thinning condition which is preset on the roadside wireless device 2. In the first embodiment, description is made using a thinning condition for “data item” (see FIG. 9) as a preset thinning condition.

When in the roadside wireless device 2 a wireless communication unit 21 receives vehicle information S4 (step SS1), the control unit 23 reads a thinning condition from a strage unit 24 and determines whether the value of a thinning level of the thinning condition is 1 or more (step SS2).

If the determination result at step SS2 is negative, the control unit 23 transitions to step SS4 without performing a thinning process.

If the determination result at step SS2 is positive, the control unit 23 executes a thinning process according to the thinning condition on the vehicle data S4 (step SS3).

Then, the control unit 23 relays vehicle data S4 to a central apparatus 4 every predetermined compilation period (e.g., one to several seconds) (step SS4). Then, the control unit 23 generates thinning information S6 every predetermined period (e.g., five minutes) and transmits the thinning information S6 to the central apparatus 4 (step SS5).

The thinning information S6 of the present embodiment includes, for example, the CPU usage rate per unit time of the control unit 23, as processing load information indicating the processing load of the roadside wireless device 2. In addition, the thinning information S6 includes number-of-vehicle information indicating the number of vehicles that are the generators of pieces of vehicle data S4 obtained by the roadside wireless device 2 before a thinning process.

As such, according to the roadside wireless device 2 of the present embodiment, since a wired communication unit 22 transmits thinning information S6 about the execution status of a thinning process to the central apparatus 4, the central apparatus 4 can grasp the execution status of a thinning process by the roadside wireless device 2.

Specifically, the central apparatus 4 can grasp the number of vehicles that are the generators of pieces of vehicle data S4 collected by the roadside wireless device 2 before a thinning process, by number-of-vehicle information included in thinning information S6. In addition, the central apparatus 4 can grasp the accuracy of the pieces of vehicle data S4 obtained from the roadside wireless device 2, by processing load information included in the thinning information S6.

<Central Apparatus of the First Embodiment>

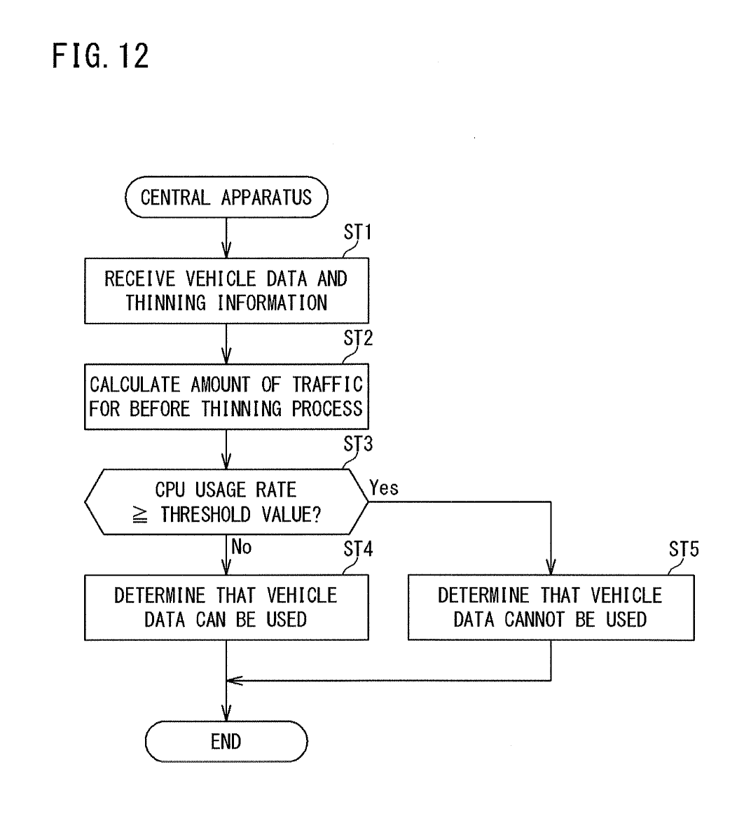

FIG. 12 is a flowchart showing an example of data processing performed by a control unit 41 of the central apparatus 4 of the first embodiment.

A data processing unit 41B in the control unit 41 of the present embodiment performs the above-described process 3 (calculation of various amounts of traffic) and process 5 (determination as to whether a calculation process for various amounts of traffic can be performed), based on the processing load information and number-of-vehicle information included in thinning information S6 which is obtained from a roadside wireless device 2. Details of these processes will be described below.

When in the central apparatus 4 a communication unit 42 receives pieces of vehicle data S4 and thinning information S6 (step ST1), the data processing unit 41B in the control unit 41 first calculates, based on number-of-vehicle information, the amount of traffic of vehicles that are the generators of the pieces of vehicle data S4 for before performing a thinning process (step ST2).

By this, the data processing unit 41B calculates the above-described amount of traffic from each of a plurality of pieces of number-of-vehicle information which are obtained at predetermined periods from the roadside wireless device 2, by which changes in the actual amount of traffic for a case of not executing a thinning process can be estimated.

Note that the process at step ST2 may be performed later than processes at steps ST3 to ST5 which will be described later.

Then, the data processing unit 41B determines, based on processing load information, whether the CPU usage rate of the roadside wireless device 2 is greater than or equal to a threshold value for a certain period of time (or a certain number of times) (step ST3).

When the determination result at step ST3 is negative, it is highly likely that a thinning process by the roadside wireless device 2 has been performed normally, and thus, the obtained pieces of vehicle data S4 have high accuracy. Hence, the data processing unit 41B determines that the above-described pieces of vehicle data S4 can be used, i.e., a traffic flow diagnosis process can be executed (step ST4), and ends the processing.

On the other hand, when the determination result at step ST3 is positive, it is less likely that a thinning process by the roadside wireless device 2 has been performed normally, and thus, the obtained pieces of vehicle data S4 have low accuracy. Hence, the data processing unit 41B determines that the above-described pieces of vehicle data S4 cannot be used, i.e., a traffic flow diagnosis process cannot be executed (step ST5), and ends the processing.

As described above, according to the central apparatus 4 of the present embodiment, by the communication unit 42 receiving thinning information S6 about the execution status of a thinning process from a roadside wireless device 2, the central apparatus 4 can grasp the execution status of a thinning process by the roadside wireless device 2.

In addition, since the central apparatus 4 performs a predetermined process based on the received thinning information S6, the central apparatus 4 can perform an appropriate process that suits the execution status of a thinning process by the roadside wireless device 2.

Specifically, the central apparatus 4 can determine whether a calculation process for various amounts of traffic can be performed, based on processing load information included in the thinning information S6. In addition, the central apparatus 4 can calculate the amount of traffic of vehicles that are the generators of pieces of vehicle data S4 for before a thinning process, based on number-of-vehicle information included in the thinning information S6.

### Second Embodiment

<Roadside Wireless Device of a Second Embodiment>

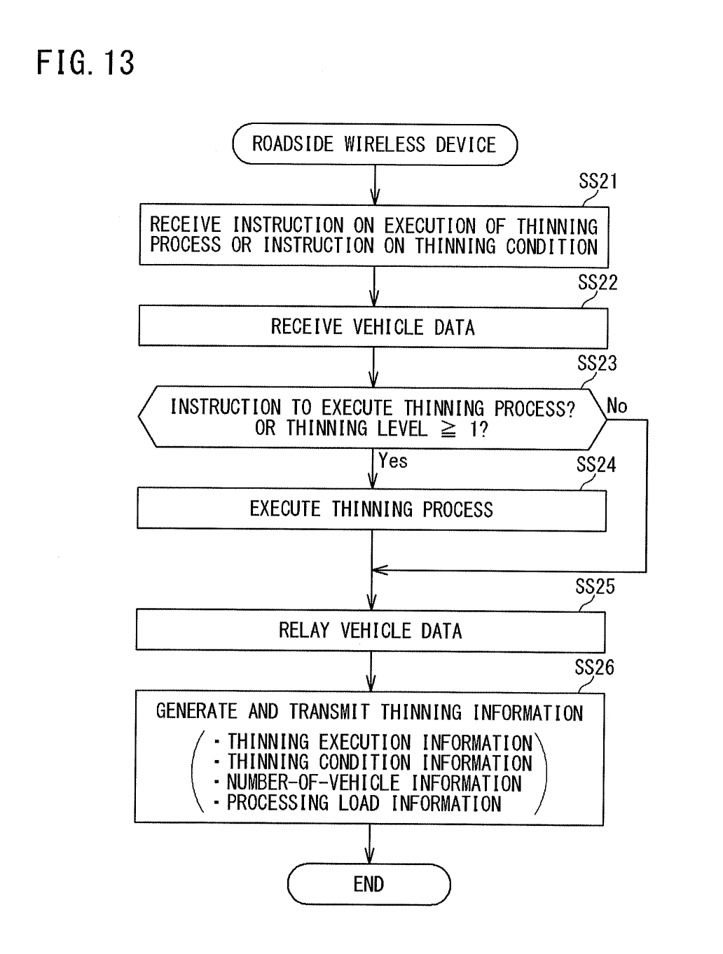

FIG. 13 is a flowchart showing an example of a data relaying process performed by a control unit 23 of a roadside wireless device 2 of a second embodiment.

The roadside wireless device 2 of the second embodiment differs from a roadside wireless device 2 of the first embodiment in that the roadside wireless device 2 performs a thinning process in response to a communication instruction from a central apparatus 4.

When a wired communication unit 22 of the roadside wireless device 2 receives an instruction on the execution of a thinning process or an instruction on a thinning condition from the central apparatus 4 (step SS21), the wired communication unit 22 stores the instruction in a strage unit 24.

Note that the instruction on the execution of a thinning process includes an instruction on whether to execute a thinning process. Note also that the instruction on a thinning condition includes the content of a thinning process (e.g., conditional content such as removal of a free area which is a data item). Besides the conditional content, the content of a thinning process may include a combination of a thinning process type and a thinning level therefor.

Then, when a wireless communication unit 21 of the roadside wireless device 2 receives vehicle information S4 (step SS22), the control unit 23 reads the above-described instruction from the strage unit 24 and makes the following determination (step SS23).

Specifically, when the instruction read from the strage unit 24 is an instruction on the execution of a thinning process, it is determined whether the instruction is an instruction to “execute a thinning process”. Alternatively, when the instruction read from the strage unit 24 is an instruction on a thinning condition, it is determined whether the value of a thinning level of the thinning condition is 1 or more.

If the determination result at step SS23 is negative, the control unit 23 transitions to step SS25 without performing a thinning process.

If the determination result at step SS23 is positive, the control unit 23 executes a thinning process according to the above-described instruction on the vehicle data S4 (step SS24).

Then, the control unit 23 relays vehicle data S4 to the central apparatus 4 every predetermined compilation period (e.g., one to several seconds) (step SS25). Then, the control unit 23 generates thinning information S6 every predetermined period (e.g., five minutes) and transmits the thinning information S6 to the central apparatus 4 (step SS26).

The thinning information S6 of the present embodiment includes, when the roadside wireless device 2 has obtained an instruction on the execution of a thinning process, thinning execution information indicating whether a thinning process has been executed.

Alternatively, the thinning information S6 includes, when the roadside wireless device 2 has obtained an instruction on a thinning condition, for example, conditional content actually used in a thinning process, as thinning condition information that allows to identify a thinning condition actually used in a thinning process. Note that when the obtained instruction on a thinning condition is a combination of a thinning process type and a thinning level, the thinning information S6 may include, as thinning condition information, a thinning process type and a thinning level that are actually used in a thinning process.

In addition, the thinning information S6 includes, for example, the CPU usage rate per unit time of the control unit 23, as processing load information indicating the processing load of the roadside wireless device 2. Furthermore, the thinning information S6 includes number-of-vehicle information indicating the number of vehicles that are the generators of pieces of vehicle data S4 obtained by the roadside wireless device 2 before a thinning process.

As such, according to the roadside wireless device 2 of the present embodiment, the following functions and effects are provided in addition to the functions and effects of the roadside wireless device 2 of the above-described first embodiment.

Specifically, the central apparatus 4 can grasp whether a roadside wireless device 2 has executed a thinning process, by thinning execution information included in thinning information S6. In addition, the central apparatus 4 can grasp a thinning condition actually used in a thinning process by the roadside wireless device 2, by thinning condition information included in the thinning information S6.

<Central Apparatus of the Second Embodiment>

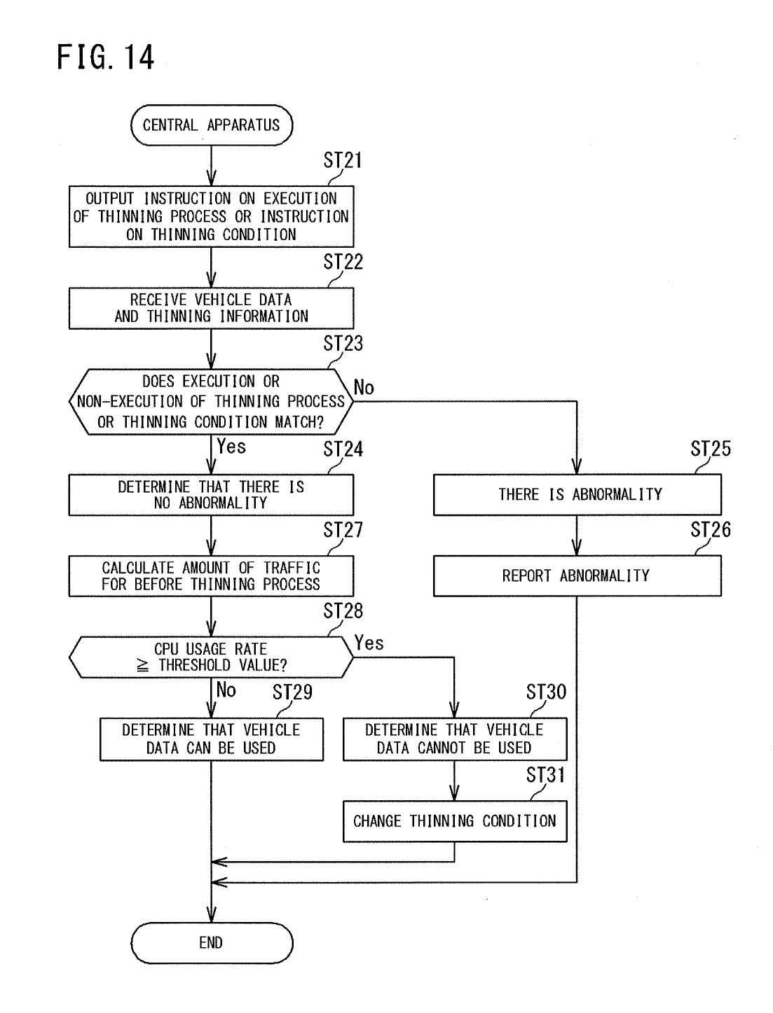

FIG. 14 is a flowchart showing an example of data processing performed by a control unit 41 of the central apparatus 4 of the second embodiment.

The central apparatus 4 of the second embodiment differs from a central apparatus 4 of the first embodiment in that processing contents to be executed by the central apparatus 4 include the above-described process 1 and process 4 in addition to processing contents (process 3 and process 5) executed by the central apparatus 4 of the first embodiment.

Specifically, a data processing unit 41B in the control unit 41 of the present embodiment performs process 1 (detection of an abnormality in a thinning process), based on thinning execution information or thinning condition information which is included in thinning information S6 obtained from a roadside wireless device 2.

In addition, the data processing unit 41B performs process 3 (calculation of various amounts of traffic), based on number-of-vehicle information included in the thinning information S6.

Furthermore, the data processing unit 41B performs process 4 (change of the thinning condition) and process 5 (determination as to whether a calculation process for various amounts of traffic can be performed), based on processing load information included in the thinning information S6. Details of these processes will be described below.

In the central apparatus 4, a thinning instructing unit 41A in the control unit 41 first outputs an instruction on the execution of a thinning process or an instruction on a thinning condition to the roadside wireless device 2 (step ST21). Note that when, upon outputting an instruction on the execution of a thinning process, the instruction is an instruction to “execute a thinning process”, the thinning instructing unit 41A also outputs an instruction on a thinning condition in addition to the instruction.

Thereafter, when a communication unit 42 receives pieces of vehicle data S4 and thinning information S6 from the roadside wireless device 2 (step ST22), the data processing unit 41B in the control unit 41 performs the following determination based on thinning execution information or thinning condition information (step ST23).

Specifically, when the thinning instructing unit 41A has outputted an instruction on the execution of a thinning process, the data processing unit 41B compares the instruction on the execution of a thinning process with the thinning execution information to determine whether the execution or non-execution of a thinning process matches between the instruction and the thinning execution information.

Alternatively, when the thinning instructing unit 41A has outputted an instruction on a thinning condition, the data processing unit 41B compares the instruction on a thinning condition with the thinning condition information to determine, for example, whether the conditional content of the thinning condition matches between the instruction and the thinning condition information. Note that when the instruction on a thinning condition is a combination of a thinning process type and a thinning level, a determination may be made as to whether the combination matches between the instruction and the thinning condition information.

When the determination result at step ST23 is negative, it is less likely that a thinning process has been performed normally by the roadside wireless device 2, and thus, the data processing unit 41B determines that “there is an abnormality” in the thinning process (step ST25).

In this case, the data processing unit 41B reports an alert indicating that an abnormality is possibly occurring in the roadside wireless device 2 or a communication line, to an operator of the central apparatus 4, etc., by audio, text display, etc. (step ST26), and ends the processing.

On the other hand, when the determination result at step ST23 is positive, it is highly likely that a thinning process has been performed normally by the roadside wireless device 2, and thus, the data processing unit 41B determines that “there is no abnormality” in the thinning process (step ST24), and transitions to the next step ST27.

At step ST27, the data processing unit 41B calculates, based on number-of-vehicle information, the amount of traffic of vehicles that are the generators of the pieces of vehicle data S4 for before performing a thinning process.

By this, the data processing unit 41B calculates the above-described amount of traffic from each of a plurality of pieces of number-of-vehicle information which are obtained at predetermined periods from the roadside wireless device 2, by which changes in the actual amount of traffic for a case of not executing a thinning process can be estimated.

Note that the process at step ST27 may be performed later than processes at steps ST28 to ST31 which will be described later.

Then, the data processing unit 41B determines, based on processing load information, whether the CPU usage rate of the roadside wireless device 2 is greater than or equal to a threshold value for a certain period of time (or a certain number of times) (step ST28).

When the determination result at step ST28 is negative, it is highly likely that a thinning process by the roadside wireless device 2 has been performed normally, and thus, the obtained pieces of vehicle data S4 have high accuracy. Hence, the data processing unit 41B determines that the above-described pieces of vehicle data S4 can be used, i.e., a traffic flow diagnosis process can be executed (step ST29), and ends the processing.

On the other hand, when the determination result at step ST28 is positive, it is less likely that a thinning process by the roadside wireless device 2 has been performed normally, and thus, the obtained pieces of vehicle data S4 have low accuracy. Hence, the data processing unit 41B determines that the above-described pieces of vehicle data S4 cannot be used, i.e., a traffic flow diagnosis process cannot be executed (step ST30).

Then, when the thinning instructing unit 41A has outputted an instruction on a thinning condition, the data processing unit 41B changes the thinning condition to one according to the processing load of the roadside wireless device 2 (step ST31), and ends the processing. Specifically, when the roadside wireless device 2 has a high processing load, the data processing unit 41B changes the thinning condition to one for a low processing load (e.g., a thinning condition with the thinning level 1 or 2), and when the roadside wireless device 2 has a low processing load, the data processing unit 41B changes the thinning condition to one for a high processing load (e.g., a thinning condition with the thinning level 4 or 5).

As described above, according to the central apparatus 4 of the present embodiment, the following functions and effects are provided in addition to the functions and effects of the central apparatus 4 of the above-described first embodiment.

Specifically, the central apparatus 4 can detect an abnormality in a thinning process, based on thinning execution information or thinning condition information. In addition, the central apparatus 4 can change the thinning condition, according to the processing load of a roadside wireless device 2. These functions and effects are effective particularly when a thinning condition is set in response to a communication instruction from the central apparatus 4 as in the present embodiment.

### Third Embodiment

<Roadside Wireless Device of a Third Embodiment>

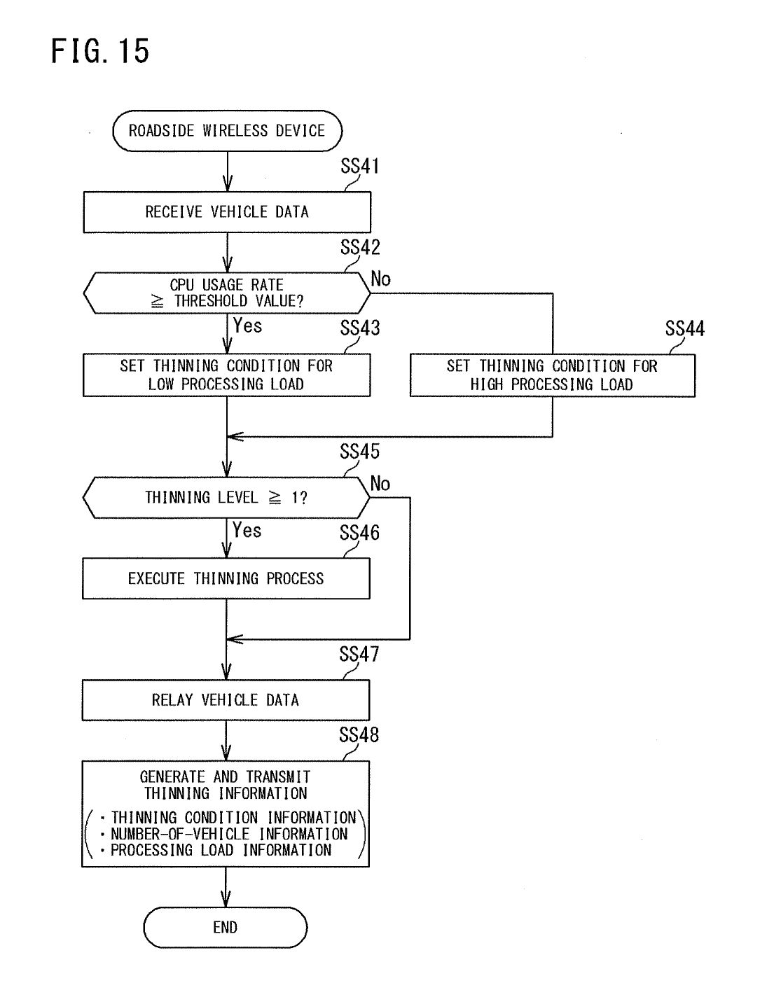

FIG. 15 is a flowchart showing an example of a data relaying process performed by a control unit 23 of a roadside wireless device 2 of a third embodiment.

The roadside wireless device 2 of the third embodiment differs from roadside wireless devices 2 of the first and second embodiments in that the roadside wireless device 2 dynamically changes and sets a thinning condition.

When in the roadside wireless device 2 a wireless communication unit 21 receives vehicle information S4 (step SS41), the control unit 23 determines whether the CPU usage rate which is the processing load of the roadside wireless device 2 is greater than or equal to a threshold value (step SS42).

If the determination result at step SS42 is positive, the control unit 23 sets a thinning condition for a low processing load (e.g., a thinning condition with the thinning level 1 or 2) (step SS43).

If the determination result at step SS42 is negative, the control unit 23 sets a thinning condition for a high processing load (e.g., a thinning condition with the thinning level 4 or 5) (step SS44).

Note that although in the present embodiment the thinning condition is dynamically changed according to the processing load of the roadside wireless device 2, the thinning condition may be changed according to the amount of collected vehicle data S4.

Then, the control unit 23 determines whether the value of a thinning level of the thinning condition is 1 or more (step SS45).

If the determination result at step SS45 is negative, the control unit 23 transitions to step SS47 without performing a thinning process.

If the determination result at step SS42 is positive, the control unit 23 executes a thinning process on the vehicle data S4, based on the thinning condition set at step SS43 or SS44 (step SS46).

Then, the control unit 23 relays vehicle data S4 to a central apparatus 4 every predetermined compilation period (e.g., one to several seconds) (step SS47). Then, the control unit 23 generates thinning information S6 every predetermined period (e.g., five minutes) and transmits the thinning information S6 to the central apparatus 4 (step SS48).

The thinning information S6 of the present embodiment includes, for example, a thinning level as thinning condition information that allows to identify a thinning condition actually used in a thinning process. In addition, the thinning information S6 includes, for example, the CPU usage rate per unit time of the control unit 23, as processing load information indicating the processing load of the roadside wireless device 2. Furthermore, the thinning information S6 includes number-of-vehicle information indicating the number of vehicles that are the generators of pieces of vehicle data S4 obtained by the roadside wireless device 2 before a thinning process.

As such, according to the roadside wireless device 2 of the present embodiment, the following function and effect are provided in addition to the functions and effects of the roadside wireless device 2 of the above-described first embodiment.

Specifically, the central apparatus 4 can grasp a thinning condition actually used in a thinning process by a roadside wireless device 2, by thinning condition information included in thinning information S6.

<Central Apparatus of the Third Embodiment>

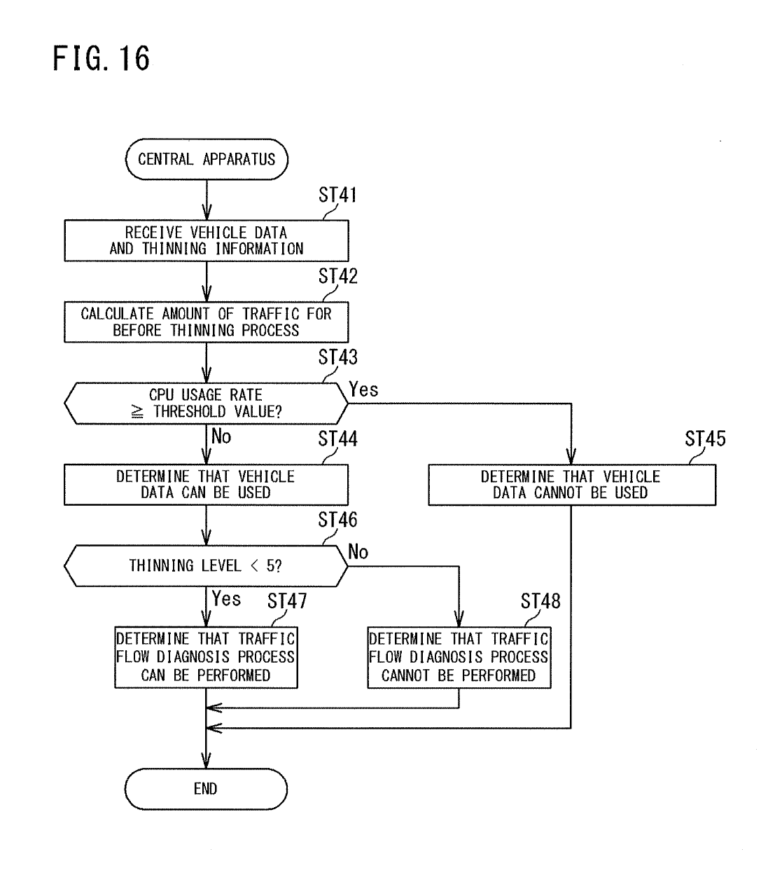

FIG. 16 is a flowchart showing an example of data processing performed by a control unit 41 of the central apparatus 4 of the third embodiment.

The central apparatus 4 of the third embodiment differs from a central apparatus 4 of the first embodiment in that processing contents to be executed by the central apparatus 4 include the above-described process 2 in addition to processing contents (process 3 and process 5) executed by the central apparatus 4 of the first embodiment.

Specifically, a data processing unit 41B in the control unit 41 of the present embodiment performs process 3 (calculation of various amounts of traffic), based on number-of-vehicle information included in thinning information S6.

In addition, the data processing unit 41B performs process 5 (determination as to whether a calculation process for various amounts of traffic can be performed), based on processing load information included in the thinning information S6.

Furthermore, the data processing unit 41B performs process 2 (determination as to whether a traffic flow diagnosis process can be performed), based on thinning condition information included in the thinning information S6 which is obtained from a roadside wireless device 2. Details of these processes will be described below.

When in the central apparatus 4 a communication unit 42 receives pieces of vehicle data S4 and thinning information S6 (step ST41), the data processing unit 41B in the control unit 41 first calculates, based on number-of-vehicle information, the amount of traffic of vehicles that are the generators of the pieces of vehicle data S4 for before performing a thinning process (step ST42).

By this, the data processing unit 41B calculates the above-described amount of traffic from each of a plurality of pieces of number-of-vehicle information which are obtained at predetermined periods from the roadside wireless device 2, by which changes in the actual amount of traffic for a case of not executing a thinning process can be estimated.

Note that the process at step ST42 may be performed after processes at steps ST43 to ST45 which will be described later, or after processes at steps ST46 to ST48 which will be described later.

Then, the data processing unit 41B determines, based on processing load information, whether the CPU usage rate of the roadside wireless device 2 is greater than or equal to a threshold value for a certain period of time (or a certain number of times) (step ST43).

When the determination result at step ST43 is positive, it is less likely that a thinning process by the roadside wireless device 2 has been performed normally, and thus, the obtained pieces of vehicle data S4 have low accuracy. Hence, the data processing unit 41B determines that the above-described pieces of vehicle data S4 cannot be used, i.e., a traffic flow diagnosis process cannot be executed (step ST45), and ends the processing.

On the other hand, when the determination result at step ST43 is negative, it is highly likely that a thinning process by the roadside wireless device 2 has been performed normally, and thus, the obtained pieces of vehicle data S4 have high accuracy. Hence, the data processing unit 41B determines that the above-described pieces of vehicle data S4 can be used, i.e., a traffic flow diagnosis process can be executed (step ST44), and transitions to the next step ST46.

At step ST46, the data processing unit 41B determines whether the value of a thinning level which is thinning condition information is less than 5.

When the determination result at step ST46 is positive, the pieces of vehicle information S4 include location information and time information that are required for a process of estimating a cause of traffic jam (traffic flow diagnosis process) (see FIG. 9). Hence, the data processing unit 41B determines that a traffic flow diagnosis process using the above-described pieces of vehicle data S4 can be performed (step ST47), and ends the processing.

On the other hand, when the determination result at step ST46 is negative, the pieces of vehicle information S4 do not include location information and time information that are required for a process of estimating a cause of traffic jam (traffic flow diagnosis process) (see FIG. 9). Hence, the data processing unit 41B determines that a traffic flow diagnosis process using the above-described pieces of vehicle data S4 cannot be performed (step ST48), and ends the processing.

Note that although, at steps ST46 to ST48 of the present embodiment, a determination as to whether a traffic flow diagnosis process can be performed is made based on the thinning condition for “data item”, when a thinning condition for “positioning accuracy” is used, a determination as to whether a traffic flow diagnosis process can be performed can be made based on this thinning condition.

Specifically, when the positioning accuracy is class 2 to 3 m or more (when the thinning level is “5” in FIG. 9), based on location information of vehicle data S4, a travel lane where a vehicle that is the generator of the vehicle data S4 is located can be identified. By this, for example, an estimation that the closure of a specific travel lane is the cause of traffic jam can be made. Therefore, by setting whether the thinning level is “5” as a determination condition, a determination as to whether a traffic flow diagnosis process can be performed can be made.

As described above, according to the central apparatus 4 of the present embodiment, the following function and effect are provided in addition to the functions and effects of the central apparatus 4 of the above-described first embodiment.

Specifically, the central apparatus 4 can determine, based on thinning condition information, whether a traffic flow diagnosis process can be performed. The function and effect are effective particularly when the roadside wireless device 2 side dynamically changes the thinning condition as in the present embodiment.

<Other Variants>

Note that the embodiments disclosed here are to be considered in all respects as illustrative and not restrictive. The scope of the present invention is indicated by the claims rather than by the above-described meaning, and all changes which come within the meaning and range of equivalency of the claims are therefore intended to be embraced therein.

For example, although the above-described embodiments exemplify the case of transmitting thinning information S6 of a roadside wireless device 2 to a central apparatus 4, as shown in FIG. 10, thinning information S6 of a slave-station roadside wireless device 2 may be transmitted to the master-station roadside wireless device 2. In this case, the master-station roadside wireless device 2 serving as an external device can grasp the execution status of a thinning process by the slave-station roadside wireless device 2.

In addition, although the central apparatus 4 of each of the above-described embodiments calculates the amount of traffic as process 3 (calculation of various amounts of traffic), the central apparatus 4 may calculate the travel time, traffic jam length, etc., of vehicles.

### REFERENCE SIGNS LIST

1: TRAFFIC SIGNAL UNIT

2: ROADSIDE WIRELESS DEVICE (ROADSIDE COMMUNICATION DEVICE)

3: ON-VEHICLE WIRELESS DEVICE

4: CENTRAL APPARATUS

5: VEHICLE

6: ROADSIDE DETECTOR

7: COMMUNICATION LINE

8: ROUTER

9: ROUTER

10: SIGNAL LIGHT UNIT

11: TRAFFIC SIGNAL CONTROLLER

12: SIGNAL CONTROL LINE

20: ANTENNA

21: WIRELESS COMMUNICATION UNIT (RECEIVING UNIT)

22: WIRED COMMUNICATION UNIT (TRANSMITTING UNIT)

23: CONTROL UNIT

23A: RADIO TRANSMISSION CONTROL UNIT

23B: WIRED TRANSMISSION CONTROL UNIT

23C: DATA RELAY UNIT (RELAY UNIT)

24: STRAGE UNIT

30: ANTENNA

31: COMMUNICATION UNIT

32: CONTROL UNIT

32A: TRANSMISSION CONTROL UNIT

32B: DATA RELAY UNIT

33: STRAGE UNIT

41: CONTROL UNIT

41A: THINNING INSTRUCTING UNIT (THINNING EXECUTION INSTRUCTION UNIT, THINNING CONDITION INSTRUCTING UNIT)

41B: DATA PROCESSING UNIT

42: COMMUNICATION UNIT

43: STRAGE UNIT

A: COMMUNICATION AREA

Ji: INTERSECTION

Ni: COMMUNICATION NODE

S1: SIGNAL CONTROL INSTRUCTION

S2: TRAFFIC INFORMATION

S3: EXECUTION INFORMATION

S4: VEHICLE DATA

S5: DETECTION INFORMATION

S6: THINNING INFORMATION

S7: SLOT INFORMATION Page 9

1. A roadside communication device having a data relay function, the roadside communication device comprising:
a receiving unit that receives mobile object data whose generator is a mobile object;
a relay unit capable of relaying the mobile object data, the relaying involving a thinning process of an amount of data; and
a transmitting unit that transmits thinning information about an execution status of the thinning process to an external device.

2. The roadside communication device according to claim 1, wherein the thinning information includes thinning execution information indicating whether the thinning process has been executed.

3. The roadside communication device according to claim 1, wherein the thinning information includes thinning condition information that allows to identify a thinning condition actually used in the thinning process.

4. The roadside communication device according to claim 1, wherein the thinning information includes number-of-mobile-object information indicating a number of mobile objects each of which is a generator of mobile object data received before the thinning process.

5. The roadside communication device according to claim 1, wherein the thinning information includes processing load information indicating a processing load of the roadside communication device.

6. A data relay method for a roadside communication device having a data relay function, the data relay method comprising:
a first step of receiving, by a receiving unit of the roadside communication device, mobile object data whose generator is a mobile object;
a second step of relaying the mobile object data by a relay unit of the roadside communication device, the relaying involving a thinning process of an amount of data; and
a third step of transmitting, by a transmitting unit of the roadside communication device, thinning information about an execution status of the thinning process to an external device.

7. A central apparatus capable of obtaining mobile object data whose generator is a mobile object, from a roadside communication device having a data relay function involving a thinning process of an amount of data, the central apparatus comprising:
a communication unit that receives thinning information about an execution status of the thinning process from the roadside communication device; and
a control unit that performs a predetermined process based on the thinning information received by the communication unit.

8. The central apparatus according to claim 7, further comprising a thinning execution instructing unit that outputs an instruction on execution of the thinning process to the roadside communication device, wherein
the thinning information includes thinning execution information indicating whether the thinning process has been executed, and
as the predetermined process, the control unit detects an abnormality in the thinning process by comparing the instruction outputted by the thinning execution instructing unit with the thinning execution information.

9. The central apparatus according to claim 7, further comprising a thinning condition instructing unit that outputs an instruction on a thinning condition of the thinning process to the roadside communication device, wherein
the thinning information includes thinning condition information that allows to identify a thinning condition actually used by the roadside communication device, and
as the predetermined process, the control unit detects an abnormality in the thinning process by comparing the instruction outputted by the thinning condition instructing unit with the thinning condition information.

10. The central apparatus according to claim 7, wherein
the thinning information includes at least one of thinning execution information, thinning condition information, and processing load information, the thinning execution information indicating whether the thinning process has been executed, the thinning condition information allowing to identify a thinning condition actually used by the roadside communication device, and the processing load information indicating a processing load of the roadside communication device, and
as the predetermined process, the control unit determines, for at least one of a traffic flow diagnosis process and a calculation process for various amounts of traffic, whether the process can be performed, based on the thinning information.

11. The central apparatus according to claim 7, wherein
the thinning information includes number-of-mobile-object information indicating a number of mobile objects each of which is a generator of mobile object data relayed by the roadside communication device before the thinning process, and
as the predetermined process, the control unit calculates various amounts of traffic based on the number-of-mobile-object information.

12. The central apparatus according to claim 7, further comprising a thinning condition instructing unit that outputs an instruction on a thinning condition of the thinning process to the roadside communication device, wherein
the thinning information includes processing load information indicating a processing load of the roadside communication device, and
as the predetermined process, the control unit changes the thinning condition to be instructed to the roadside communication device, according to the processing load information.

13. A computer program for causing a computer to perform a process to be performed by a central apparatus capable of obtaining mobile object data whose generator is a mobile object, from a roadside communication device having a data relay function involving a thinning process of an amount of data, the computer program causing the computer to function as:
a communication unit that receives thinning information about an execution status of the thinning process from the roadside communication device; and
a control unit that performs a predetermined process based on the thinning information received by the communication unit.

14. A data processing method for a central apparatus capable of obtaining mobile object data whose generator is a mobile object, from a roadside communication device having a data relay function involving a thinning process of an amount of data, the data processing method comprising:
a first step of receiving, by a communication unit of the central apparatus, thinning information about an execution status of the thinning process from the roadside communication device; and
a second step of performing, by a control unit of the central apparatus, a predetermined process based on the thinning information received by the communication unit.
